(19) United States
(12) Patent Application Publication
(10) Pub. No.: US 2026/0173993 A1
(43) Pub. Date: Jun. 25, 2026

(54) PATH GENERATION METHODS, CONTROLLERS, TRAVEL CONTROL SYSTEMS, WORK VEHICLES, PROCESSORS, AND COMPUTER PROGRAMS

(71) Applicant: Kubota Corporation, Osaka (JP)

(72) Inventors: Tomoya SUYAMA, Sakai-shi (JP); Yuji OKUYAMA, Sakai-shi (JP)

(21) Appl. No.: 19/422,971

(22) Filed: Dec. 17, 2025

(30) Foreign Application Priority Data
Dec. 19, 2024 (JP) 2024-224402

(51) Int. Cl. A01B 69/04; G05D 1/646; G05D 105/15; G05D 107/20; G05D 109/10; G05D 111/50

(52) U.S. Cl. CPC A01B 69/008; G05D 1/646; G05D 2105/15; G05D 2107/21; G05D 2109/10; G05D 2111/58

(57) ABSTRACT

A method to be executed by one or more computers generates a path for a work vehicle having an implement linked thereto to travel within a field. The path includes a temporary stop position in a peripheral region which is not a work area within the field but is an area provided along at least a portion of an outer periphery of the field. The method includes calculating a space that is defined by a trajectory of the work vehicle and the implement when the work vehicle has performed a predetermined turn, based on a size of the work vehicle, a size of the implement, and a position relationship between the work vehicle and the implement, and determining the temporary stop position based on the space.

### CROSS REFERENCE TO RELATED APPLICATIONS

This application claims the benefit of priority to Japanese Patent Application No. 2024-224402 filed on Dec. 19, 2024. The entire contents of this application are hereby incorporated herein by reference.

### BACKGROUND OF THE INVENTION

### 1. Field of the Invention

The present invention relates to path generation methods, controllers, travel control systems, work vehicles, processors, and non-transitory computer-readable media including computer programs.

### 2. Description of the Related Art

As attempts in next-generation agriculture, research and development of smart agriculture utilizing ICT (Information and Communication Technology) and IoT (Internet of Things) is under way. Research and development is also directed to the automation and unmanned use of tractors or other work vehicles to be used in the field. For example, work vehicles which travel via automatic steering by utilizing a positioning system that is capable of precise positioning, e.g., a GNSS (Global Navigation Satellite System), are coming into practical use.

International Publication No. 2022/107586 describes a work vehicle that is capable of autonomous movement among a plurality of rows of trees in an orchard, such as a vineyard, by using an SLAM (Simultaneous Localization and Mapping) technique that simultaneously performs localization and map generation. International Publication No. 2022/107586 describes, in an orchard, a work vehicle traveling among a plurality of rows of trees, where the work vehicle performs mowing, preventive pest control, or other work by using an implement (agricultural implement) that is linked to the work vehicle.

### SUMMARY OF THE INVENTION

There is a desire to achieve a more efficient travel of a work vehicle having an implement linked thereto within a field. Details thereof will be described later.

Example embodiments of the present invention provide path generation methods, controllers, travel control systems, work vehicles, processors, and non-transitory computer-readable media including computer programs to achieve a more efficient travel of a work vehicle having an implement linked thereto within a field.

According to example embodiments of the present invention, solutions as described in the following Items are provided.

### Item 1

A method, to be executed by one or more computers, to generate a path for a work vehicle having an implement linked thereto to travel within a field, the path including a temporary stop position in a peripheral region which is not a work area within the field but is an area provided along at least a portion of an outer periphery of the field, the method including calculating a space that is defined by a trajectory of the work vehicle and the implement when the work vehicle has performed a predetermined turn, based on a size of the work vehicle, a size of the implement, and a position relationship between the work vehicle and the implement, and determining the temporary stop position based on the space.

### Item 2

The method of Item 1, wherein the calculating the space includes acquiring information of a turning direction and a turning angle of the predetermined turn, and calculating the trajectory based on the turning direction and the turning angle.

### Item 3

The method of Item 1 or 2, wherein the calculating the space includes acquiring information of an upper limit value of a steering angle of the work vehicle that is tolerable when the work vehicle performs the predetermined turn, and calculating the trajectory based on the upper limit value of the steering angle.

### Item 4

The method of any one of Items 1 to 3, wherein the calculating the space includes, during travel between the temporary stop position and a travel restart position in the work area after stopping at the temporary stop position, acquiring information of one or more tolerable motions selected from among forward travel, backward travel, right turn, and left turn motions, and calculating the trajectory based on the one or more tolerable motions.

### Item 5

The method of any one of Items 1 to 4, wherein the path includes a turning section between the temporary stop position and a travel restart position within the work area after stopping at the temporary stop position.

### Item 6

The method of any one of Items 1 to 5, wherein the calculating the space includes acquiring information of a method of linkage of the implement with the work vehicle, calculating the trajectory based on a position relationship between the work vehicle and the implement that depends on the method of linkage, and the information of the method of linkage includes information as to whether the implement is linked to the work vehicle such that an orientation of the implement is fixed relative to an orientation of the work vehicle.

### Item 7

The method of Item 6, wherein the calculating the space includes acquiring information of an upper limit value of an angular difference between the orientation of the work vehicle and the orientation of the implement that is tolerable when the work vehicle performs the predetermined turn in a case where the orientation of the implement is not fixed relative to the orientation of the work vehicle, and calculating the trajectory based on the upper limit value of the angular difference.

### Item 8

The method of any one of Items 1 to 7, wherein the calculating the space includes calculating a first length of the trajectory along a first direction that is parallel or substantially parallel to an orientation of the work vehicle before the predetermined turn, and within a length of the trajectory along a second direction intersecting the first direction, calculating a second length of a portion of the trajectory that increases in a direction opposite to a direction of the predetermined turn, relative to a length along the second direction of the work vehicle before the predetermined turn.

### Item 9

The method of Item 8, wherein the determining the temporary stop position includes determining the temporary stop position so that a rectangle that is determined by the first length and the second length is included in a predetermined region within the peripheral region.

### Item 10

The method of Item 9, wherein the predetermined region is in contact with the outer periphery of the field.

### Item 11

The method of any one of Items 1 to 10, wherein the outer periphery of the field includes a plurality of sides, and the determining the temporary stop position includes determining the temporary stop position so that the temporary stop position is located in a vicinity of one of the plurality of sides and that an orientation of the work vehicle at the temporary stop position is in a direction that is parallel or substantially parallel to a direction in which the one of the plurality of sides extends.

### Item 12

The method of any one of Items 1 to 11, wherein the determining the temporary stop position includes acquiring information as to which factor is to be prioritized between a distance of a connection path that connects the temporary stop position and a travel end position in the work area before stopping at the temporary stop position being short, and a curvature of the connection path being small, and determining the temporary stop position by generating the connection path based on the prioritized factor.

### Item 13

The method of any one of Items 1 to 12, wherein the work area includes a plurality of crop rows, and a path by which the work vehicle travels in the work area includes a path by which the work vehicle travels among the plurality of crop rows.

### Item 14

The method of Item 13, wherein the path by which the work vehicle travels in the work area further includes a path by which the work vehicle turns in a headland before and after the travel among the plurality of crop rows,

### Item 15

A controller configured or programmed to cause a work vehicle to travel along a path that is generated by the method of any one of Items 1 to 14.

### Item 16

A travel control system including a processor configured or programmed to generate a path by carrying out the method of any one of Items 1 to 14, and a controller configured or programmed to cause a work vehicle to travel along the path that is generated by the processor.

### Item 17

A work vehicle including the travel control system of Item 16, a travel device including a wheel responsible for steering, and a driver to drive the travel device.

### Item 18

A processor configured or programmed to generate a path for a work vehicle having an implement linked thereto to travel within a field, the processor including one or more processors, and one or more memories storing a computer program to be executed by the one or more processors, wherein the path includes a temporary stop position in a peripheral region which is not a work area within the field but is an area provided along at least a portion of an outer periphery of the field; and by executing the computer program, the one or more processors perform calculating a space that is defined by a trajectory of the work vehicle and the implement when the work vehicle has performed a predetermined turn, based on a size of the work vehicle, a size of the implement, and a position relationship between the work vehicle and the implement, and determining the temporary stop position based on the space.

### Item 19

A non-transitory computer-readable medium including a computer program to be executed by a processor in a processor to generate a path for a work vehicle having an implement linked thereto to travel within a field, the path including a temporary stop position in a peripheral region which is not a work area within the field but is an area provided along at least a portion of an outer periphery of the field, the computer program being executable to cause the processor to perform calculating a space that is defined by a trajectory of the work vehicle and the implement when the work vehicle has performed a predetermined turn, based on a size of the work vehicle, a size of the implement, and a position relationship between the work vehicle and the implement, and determining the temporary stop position based on the space.

### Item 20

A controller configured or programmed to perform the method of any one of Items 1 to 14.

### Item 21

A non-transitory computer-readable medium including a computer program to be executed by a computer to cause the computer to perform the method of any one of Items 1 to 14.

### Item 22

A non-transitory computer-readable medium including a computer program medium including a computer program to be executed by a computer to cause the computer to perform the method of travel control of any one of Items 1 to 14.

### Item 23

A path generation system to generate a path for a work vehicle having an implement linked thereto to travel within a field, the system including the controller of Item 20.

### Item 24

A processor configured or programmed to generate a path for a work vehicle having an implement linked thereto to travel within a field, wherein the path includes a temporary stop position in a peripheral region which is not a work area within the field but is an area provided along at least a portion of an outer periphery of the field, and the processor is configured or programmed to calculate a space that is defined by a trajectory of the work vehicle and the implement when the work vehicle has performed a predetermined turn, based on a size of the work vehicle, a size of the implement, and a position relationship between the work vehicle and the implement, and to determine the temporary stop position based on the space.

### Item 25

A travel control system for a work vehicle including the processor of Item 24, and a controller configured or programmed to cause the work vehicle to travel along the path generated by the processor.

### Item 26

A travel control system for a work vehicle including the processor of Item 24, and a controller configured or programmed to cause the work vehicle to travel along the path generated by the processor, and a driver to drive a travel device of the work vehicle, wherein the controller is configured or programmed to cause the work vehicle to travel via self-driving, by controlling the driver based on the path generated by the processor.

Example embodiments of the present invention may be implemented using devices, systems, methods, integrated circuits, computer programs, non-transitory computer-readable storage media, or any combination thereof. The computer-readable storage media may be inclusive of volatile storage media, or non-volatile storage media. The device may include a plurality of devices. In the case where the device includes two or more devices, the two or more devices may be provided within a single apparatus, or divided over two or more separate apparatuses.

According to example embodiments of the present invention, travel control systems, work vehicles, and methods of travel control that enable efficient performance of iterative operations (including travel and other operations) of a work vehicle are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view schematically showing an example of a work vehicle and an implement according to an example embodiment of the present invention.

FIG. 2 is a diagram schematically showing an example of a path for a work vehicle having an implement linked thereto to travel within a field.

FIG. 3 is a flowchart showing an example of a procedure of path generation according to an example embodiment of the present invention.

FIG. 4 is a diagram schematically showing another example of a path for a work vehicle having an implement linked thereto to travel within a field.

FIG. 5A is a block diagram showing an example schematic configuration of a travel control system 1000 according to an example embodiment of the present invention.

FIG. 5B is a block diagram showing an example configuration of a processor 530.

FIG. 5C is a schematic diagram showing an example configuration of a travel control system according to an example embodiment of the present invention.

FIG. 6 is a block diagram schematically showing a series of processes of path generation for a work vehicle that may be executed by a processor according to an example embodiment of the present invention.

FIG. 7 is a flowchart showing an example of a process to be performed at step S200.

FIG. 8 is a schematic diagram for describing an example method of calculating a first space.

FIG. 9A is a schematic diagram for describing an example method of determining a temporary stop position based on a calculated first space.

FIG. 9B is a schematic diagram for describing an example method of determining a temporary stop position based on a calculated first space.

FIG. 10 is a flowchart showing another example of the process to be performed at step S200.

FIG. 11 is a flowchart showing another example of the process to be performed at step S200.

FIG. 12 is a flowchart showing another example of the process to be performed at step S200.

FIG. 13 is a flowchart showing another example of the process to be performed at step S200.

FIG. 14 is a schematic top view for describing a position relationship between a work vehicle and an implement that is linked to the work vehicle via towing.

FIG. 15 is a flowchart showing an example of a process to be performed at step S400.

FIG. 16 is a schematic diagram for describing an example method of determining a temporary stop position.

FIG. 17 is a schematic side view showing a work vehicle having another implement linked thereto.

FIG. 18 is a schematic diagram for describing an example method of calculating a first space.

FIG. 19 is a schematic diagram for describing an example method of calculating a first space.

FIG. 20 is a block diagram schematically showing an example configuration for a work vehicle and an implement according to an example embodiment of the present invention.

### DETAILED DESCRIPTION OF THE EXAMPLE EMBODIMENTS

In the present specification, a “work vehicle” means a vehicle for use in performing work in a work area. A “work area” is any place where work may be performed, e.g., a field, a mountain forest, or a construction site. A “field” is any place where agricultural work may be performed, e.g., an orchard, an agricultural field, a paddy field, a cereal farm, or a pasture. A work vehicle can be an agricultural machine such as a tractor, a rice transplanter, a combine, a vehicle for crop management, or a riding mower, or a vehicle for non-agricultural purposes such as a construction vehicle or a snowplow vehicle. A work vehicle may be configured so that an implement (also referred to as a “task device” or a “task apparatus”) that is suitable for the content of work can be attached to at least one of its front and its rear. In particular, an implement that is attached to an agricultural tractor may be referred to as an “agricultural implement”. Traveling of a work vehicle that occurs while the work vehicle performs work by using an implement may be referred to as “tasked travel”. The “operation” of a work vehicle includes not only travel of the work vehicle but also other operations.

The methods of linking an implement to a work vehicle are generally categorized into “direct mounting” or “towing”. In the case of direct mounting, the implement is attached to the front or the rear of the work vehicle in such a manner that the orientation of the implement is fixed relative to the orientation of the work vehicle. An implement that is linked via direct mounting may basically be configured so that it never touches the ground during movement (i.e., travel) of the work vehicle. In the case of towing, the implement is linked to the rear of the work vehicle in such a manner that the orientation of the implement is not fixed relative to the orientation of the work vehicle, and the implement is to be towed by the work vehicle. A towing type implement may have a wheel(s). A towing type implement may or may not have motive power for movement (travel) on its own.

In the present specification, unless otherwise specified, the “orientation” of a work vehicle or an implement is meant to be the orientation of the work vehicle or implement in a two-dimensional coordinate system. For example, it may be the orientation of the work vehicle or implement as projected onto an xy plane (i.e., the horizontal plane) where an opposite direction of the direction of gravity (vertically upward direction) defines the +z direction.

“Self-driving” means controlling the travel of a vehicle based on the action of a controller, rather than through manual operation of a driver. During self-driving, not only the travel of the vehicle, but also the task operation (e.g., the operation of the implement) may also be automatically controlled. A vehicle that is traveling via self-driving is said to be “self-traveling”. The controller may be configured or programmed to control at least one of steering, adjustment of traveling speed, and starting and stopping of travel as are necessary for the travel of vehicle. In the case of controlling a work vehicle having an implement attached thereto, the controller may control be configured or programmed to operations such as raising or lowering of the implement, starting and stopping of the operation of the implement, and the like. Travel via self-driving includes not only the travel of a vehicle toward a destination along a predetermined path, but also the travel of merely following a target of tracking. A vehicle performing self-driving may operate not only in a self-driving mode but also in a manual driving mode of traveling through manual operation of the driver. Traveling through manual operation of the driver is referred to as “manual traveling”. “Manual operation of a driver” includes not only manual operation by a driver on the vehicle, but also remote manipulation by a driver (operator) outside the vehicle. A vehicle performing self-driving may travel partly based on manual operation of the driver. The steering of a vehicle that is based on the action of a controller, rather than manual operation of the driver, is referred to as “automatic steering”. A portion or an entirety of the controller may be external to the vehicle. Between the vehicle and a controller that is external to the vehicle, communication of control signals, commands, data, or the like may be performed. A vehicle performing self-driving may autonomously travel while sensing the surrounding environment, without any person being involved in the control of the travel of the vehicle. A vehicle that is capable of autonomous travel can travel in an unmanned manner. During autonomous travel, detection of obstacles and avoidance of obstacles may be performed.

A “crop row” is a row of agricultural items, trees, or other plants that may grow in rows on a field, e.g., an orchard or an agricultural field, or in a forest or the like. In the description of example embodiments of the present invention, a “crop row” encompasses a “row of trees”.

Hereinafter, example embodiments of the present invention will be described more specifically. Note however that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand example embodiments of the present invention, are not intended to limit the scope of claims. In the following description, component elements having identical or similar functions are denoted by identical reference numerals.

The following example embodiments are only exemplary, and the techniques according to the present invention are not limited to the following example embodiments. For example, numerical values, shapes, materials, steps, orders of steps, etc., that are indicated in the following example embodiments are only exemplary, and admit of various modifications so long as it makes technological sense. Any one example embodiment may be combined with another.

A path generation method according to an example embodiment of the present invention, and a travel control system to cause a work vehicle along a path that is generated by the path generation method will be described. A path generation method according to an example embodiment of the present invention is a method of generating a path for a work vehicle having an implement linked thereto to travel within a field, and a path generation method and a travel control system according to an example embodiment of the present invention are applicable to the travel of a work vehicle having an implement linked thereto within a field.

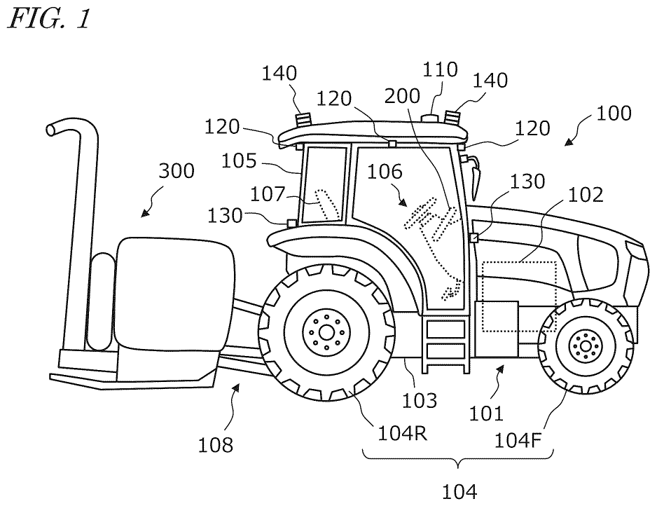

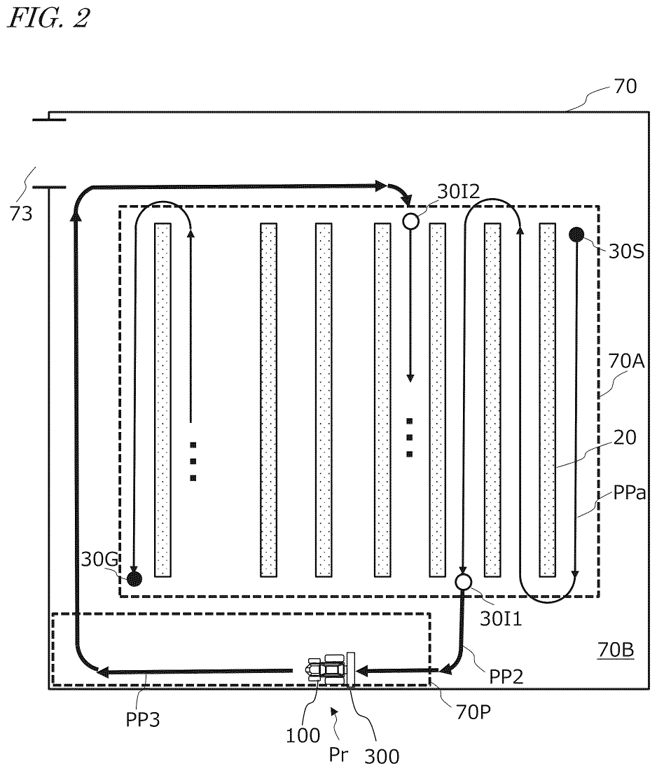

FIG. 1 is a side view schematically showing an example of a work vehicle 100 and an implement 300 that is linked to the work vehicle 100. FIG. 2 is a diagram schematically showing an example path by which the work vehicle 100 with the implement 300 linked thereto travels within a field 70. As shown in FIG. 2, while performing work by using the implement 300, the work vehicle 100 travels along a path PPa within a work area 70A of the field 70. The work area 70A includes a plurality of crop rows 20 as is illustrated, for example. In a case where the field 70 is an orchard such as a vineyard, for example, the crop rows 20 may be rows of trees. In the work area 70A, while traveling among the plurality of crop rows 20 along the path PPa from a start point 30S to an end point 30G of the path PPa, the work vehicle 100 performs a predetermined task using the implement 300 (e.g., seeding, manure spreading, mowing, preventive pest control, or the like). The path PPa by which the work vehicle 100 travels in the work area 70A further includes a paths of turning in a headland before and after the travel between crop rows 20.

Work that is performed by using the implement 300 includes agricultural work that is performed while consuming agricultural materials such as seeds, fertilizers, chemical agents, or seedlings (which hereinafter may simply be referred to as “materials”), for example. If the material becomes short while the work vehicle 100 is traveling at the same time of performing work in the work area 70A, it becomes necessary to refill the material. In such a case, in order to refill the material, the work vehicle 100 moves to in a vicinity of outer periphery of the field 70, makes a temporary stop, and then receives supply of the material. FIG. 2 illustrates the work vehicle 100 being stopped at a temporary stop position Pr. After having the material refilled at the temporary stop position Pr, the work vehicle 100 returns to the work area 70A to again perform tasked travel in the work area 70A.

While traveling in any path that connects the temporary stop position Pr located outside the work area 70A and the path PPa inside the work area 70A, the work vehicle 100 may need to turn. For example, in the illustrated example, paths connecting the temporary stop position Pr and the path PPa inside the work area 70A include a connection path PP2 that connects the temporary stop position Pr and a work end position (which may hereinafter be referred to as a “travel end position”) 30I1 in the work area 70A before stopping at the temporary stop position Pr, and a connection path PP3 that connects the temporary stop position Pr and a work restart position (which may hereinafter be referred to as a “travel restart position”) 30I2 in the work area 70A after stopping at the temporary stop position Pr. Both of the connection paths PP2 and PP3 include a turning section. In particular, regarding the turning section of the connection path PP3 after stopping at the temporary stop position Pr, a temporary stop position Pr needs to be determined that accounts for a space required for turning by the work vehicle 100 and the implement 300 being linked to the work vehicle 100. For example, the greater the size of the implement 300 is, the greater the required space for turning is. Furthermore, in a case where the implement 300 is linked to the work vehicle 100 via towing, the space must accommodate a possible movement of the implement 300 when the work vehicle 100 begins to travel, which may occur in an opposite direction to the direction in which the work vehicle 100 is steered. Placing the temporary stop position Pr at a position spaced away from the outer periphery of the field 70 can ensure a sufficient space for turning by the work vehicle 100 and the implement 300. On the other hand, vehicles to supply materials are likely to be located outside the field 70. Thus, from the standpoint of efficient refilling of materials, the temporary stop position is preferably as close to the outer periphery of the field 70 as possible.

As will be described below, according to an example embodiment of the present invention, while ensuring a space for turning the work vehicle 100 and the implement 300, the temporary stop position Pr can be determined at a position that is close to the outer periphery of the field 70, based on the size of the implement 300 and the position relationship of the implement 300 with the work vehicle 100 (e.g., the manner of being linked to the work vehicle 100). Therefore, the work vehicle 100 having the implement 300 linked thereto can efficiently travel within the field 70. During tasked travel within the work area 70A, the required timing of material refill may differ each time, which implies that the temporary stop position Pr and the paths connecting the temporary stop position Pr and the path PPa inside the work area 70A may differ each time. According to an example embodiment of the present invention, path generation can be flexibly performed in accordance with the timing of material refill, whereby the efficiency of tasked travel may be improved. A path generation method and a travel control system according to an example embodiment of the present invention can be used irrespective of whether the implement is linked to the work vehicle by via direct mounting or via towing.

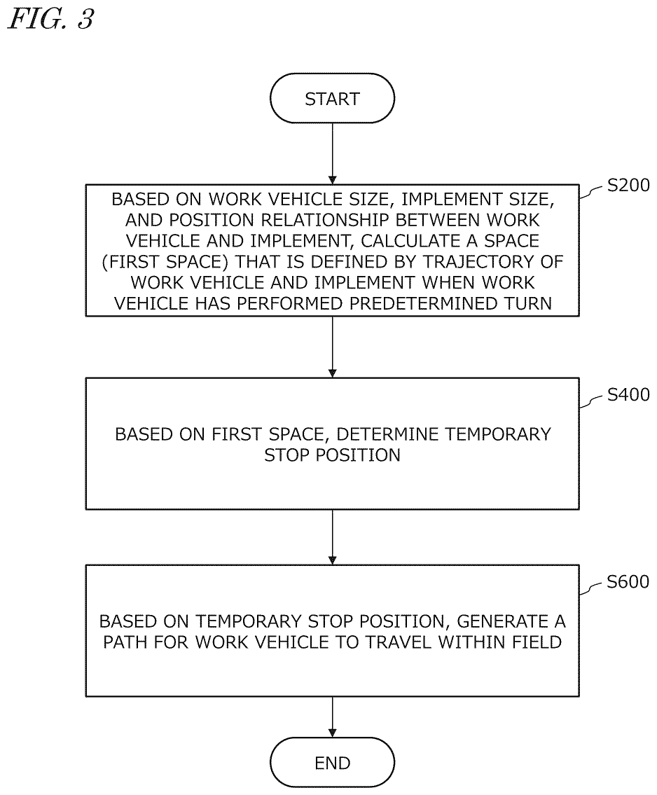

FIG. 3 is a flowchart showing an example of a procedure of path generation according to an example embodiment of the present invention. The path generation method according to the present example embodiment of the present invention, to be executed by one or more computers, is a method that generates a path by which the work vehicle 100 with the implement 300 linked thereto travels within the field 70. The path includes a temporary stop position Pr that is located in a peripheral region 70B which is not the work area 70A within the field 70 but is an area provided along at least a portion of the outer periphery of the field 70. As shown in FIG. 3, the procedure of path generation includes calculating a space that is defined by a trajectory of the work vehicle 100 and the implement 300 when the work vehicle 100 has performed a predetermined turn, based on the size of the work vehicle 100, the size of the implement 300, and the position relationship between the work vehicle 100 and the implement 300 (step S200), determining the temporary stop position Pr based on the space calculated at step S200 (step S400), and generating a path by which the work vehicle 100 travels within the field 70 based on the temporary stop position Pr (step S600). In the present specification, to calculate (or determine) based on a certain element means that the element affects the calculation (or determination) in some ways, and does not preclude any other element from affecting the calculation (or determination). For example, at step S400, the temporary stop position Pr may be determined based on the space calculated at step S200 as well as other factors. The same also applies to anywhere the expression “based on . . . ” is used in contexts outside calculation or determination.

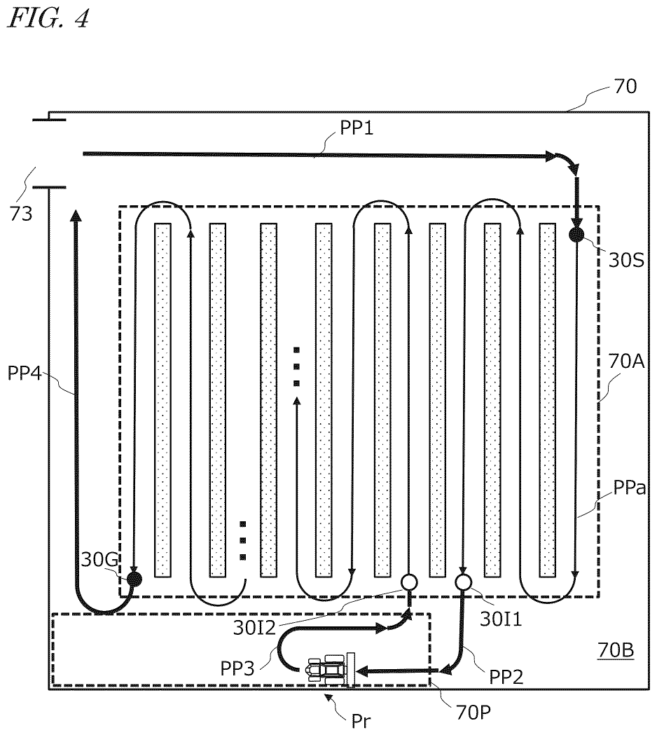

FIG. 4 is a diagram schematically showing another example of a path by which the work vehicle 100 with the implement 300 linked thereto travels within the field 70. The example shown in FIG. 4 includes a path of stopping at a temporary stop position Pr and thereafter making a “U” turn. Furthermore, as in the example shown in FIG. 4, the path by which the work vehicle 100 with the implement 300 linked thereto travels within the field 70 may further include a path PP1 that connects an entrance/exit 73 of the field 70 to the start point 30S of the path PPa inside the work area 70A and/or a path PP4 that connects the end point 30G of the path PPa inside the work area 70A to the entrance/exit 73 of the field 70.

In the illustrated example, a work end position 30I1 in the work area 70A before stopping at the temporary stop position Pr and a work restart position 30I2 in the work area 70A after stopping at the temporary stop position Pr are shown to be at different positions. Alternatively, however, they may be identical.

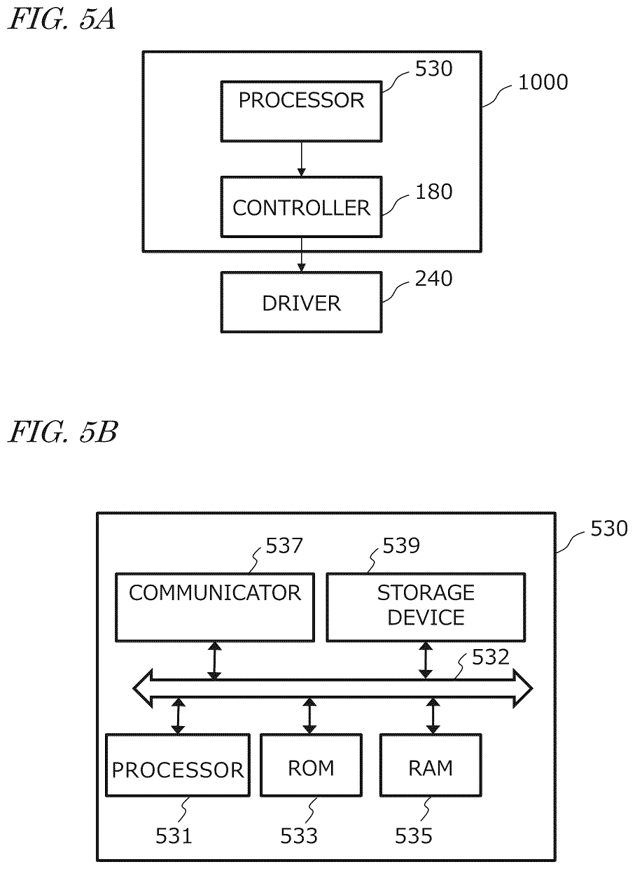

FIG. 5A is a block diagram showing an example schematic configuration of a travel control system 1000 according to an example embodiment of the present invention. The travel control system 1000 includes: a processor 530 that generates a path by carrying out the path generation method according to the present example embodiment of the present invention, and a controller 180 configured or programmed to cause work vehicle 100 to travel along the path that is generated by the processor 530.

The travel control system 1000 may be mounted to the work vehicle 100, and a portion or an entirety of the processing performed by the travel control system 1000 may be executed by one or more computers located outside the work vehicle 100.

The processor 530 may be a computer or computers configured or programmed to execute the path generation method according to the present example embodiment of the present invention. The processor 530 may be mounted to the work vehicle 100, or one or more computers located outside the work vehicle 100 may be allowed to function as a portion or an entirety of the processor 530. The processor 530 may include one or more processors and one or more memories. A portion or an entirety of the processing performed by the processor 530 may be performed inside a sensor group that is mounted to the work vehicle 100, for example. In a case where at least a portion of the processor 530 is included in the work vehicle 100, the processor 530 and the sensor group are connected so as to be capable of communication via a bus, for example. Moreover, one or more computers that are included in one or more server computers connected to a network and/or a terminal device connected to a network may function as a portion or an entirety of the processor 530.

The controller 180 may be a computer or computers that cause(s) the work vehicle 100 to travel along a path that is generated by the processor 530. The controller 180 may be realized by one or more electronic control units (ECU) that are mounted to the work vehicle 100, for example. The controller 180 can be configured or programmed to realize self-traveling of the work vehicle 100. By controlling a driver 240 that drives a travel device of the work vehicle 100 based on a path having been generated by the processor 530, the controller 180 can cause the work vehicle 100 to perform self-traveling along a path that is generated by the processor 530. While causing the work vehicle 100 to perform self-traveling, the travel control system 1000 may cause the processor 530 to generate or modify a target path for the work vehicle 100 as need be. For example, a target path including a temporary stop position may be generated as material refilling becomes necessary while the work vehicle 100 is performing tasked travel within the work area 70A. Alternatively, the remaining amount of a material may be detected while the work vehicle 100 is performing tasked travel within the work area 70A, and based on the remaining amount of the material, a target path including a temporary stop position may be generated (or modified) as need be. Note that the path generation method according to the present example embodiment of the present invention may generate a path for manual traveling of the work vehicle 100. In other words, based on a path that is generated by the processor 530, a user may perform manual traveling of the work vehicle 100.

FIG. 5B is a block diagram showing an example configuration of the processor 530. In the example of FIG. 5B, the processor 530 includes a processor 531, a ROM (Read Only Memory) 533, a RAM (Random Access Memory) 535, a communicator 537, and a storage device 539. These component elements may be connected to one another via a bus 532.

The processor 531 may be a semiconductor integrated circuit, also called a central processing unit (CPU) or a microprocessor. The processor 531 may include a graphics processing unit (GPU). The processor 531 consecutively executes a computer program describing predetermined instructions and being stored in the ROM 533, and achieves processes that are necessary for the path generation according to the present example embodiment of the present invention. The processor 530 may include a plurality of processors 531. The plurality of processors 531 may work in cooperation to perform the processes that are necessary for the path generation according to the present example embodiment of the present invention. A portion or an entirety of the processor 531 may be an FPGA (Field Programmable Gate Array), an ASIC (Application Specific Integrated Circuit), or an ASSP (Application Specific Standard Product) incorporating a CPU.

The communicator 537 is an interface to perform data communications between the processor 530 and an external computer. The communicator 537 is capable of wired communications via a CAN (Controller Area Network) or the like, or wireless communications compliant with the Bluetooth (registered trademark) standards and/or the Wi-Fi (registered trademark) standards.

The storage device 539 is able to store sensor data acquired from the sensor group 520, sensor data currently under processing, data currently under processing for generating cut-point data, etc. The storage device 539 includes a hard disk drive or a non-volatile semiconductor memory, for example.

An example of the “controller” in an example embodiment of the present invention is a computer that includes at least one processor and at least one memory storing a computer program (code) defining control processes to be executed by the processor. Another example of the “controller” is a computer equipped with an FPGA (Field-Programmable Gate Array), an ASSP (Application Specific Standard Product), an ASIC (Application-Specific Integrated Circuit), or other hardware accelerators configured to execute the control processes.

Similarly, an example of the “processor” in an example embodiment of the present invention is a computer including at least one processor and at least one memory storing a computer program (code) defining operating processes to be executed by the processor. Another example of the “processor” is a computer equipped with an FPGA, an ASIC, or other hardware accelerators configured to execute the operating process.

A “processor” in an example embodiment of the present invention is a hardware electronic circuit such as a CPU (Central Processing Unit), a GPU (Graphics Processing Unit), a DSP (Digital Signal Processor), an ISP (Image Signal Processor), or an NPU (Neural Network Processing Unit). A “memory” is a hardware electronic circuit such as a ROM (Read Only Memory) or a RAM (Random Access Memory). A portion of the memory may be a storage medium that is connected to the processor via interconnects or a network. These hardware electronic circuits may be implemented by one or more integrated circuits (IC) or large-scale integrated circuits (LSI). Each functional unit or block and its associated components within the electronic circuit may be individually manufactured as an individual integrated circuit chip, or some or all of these functional units or blocks may be combined so as to be manufactured as a single integrated circuit chip.

A program defining the operation of a processor is designed so that the processor will execute one or more functions, manipulations, steps, or process according to an example embodiment of the present invention.

FIG. 5C is a schematic diagram showing an example configuration of the travel control system according to the present example embodiment of the present invention. Some or all functions of the processor 530 may be realized by a server(s) (computer(s)) 500 and/or a terminal device(s) 600 (including mobile types and stationary types) that is connected to the communicator 537 of the processor 530 via a communications network 800. To such a communications network 800, another work vehicle (e.g., a tractor) 700 may be connected, and communications may be performed between the work vehicle 100 having the processor 530 and the other work vehicle 700. Via the communications network 800, a portion of the data used in the processing by the processor 530 may be fed from the other work vehicle 700 to the processor 530.

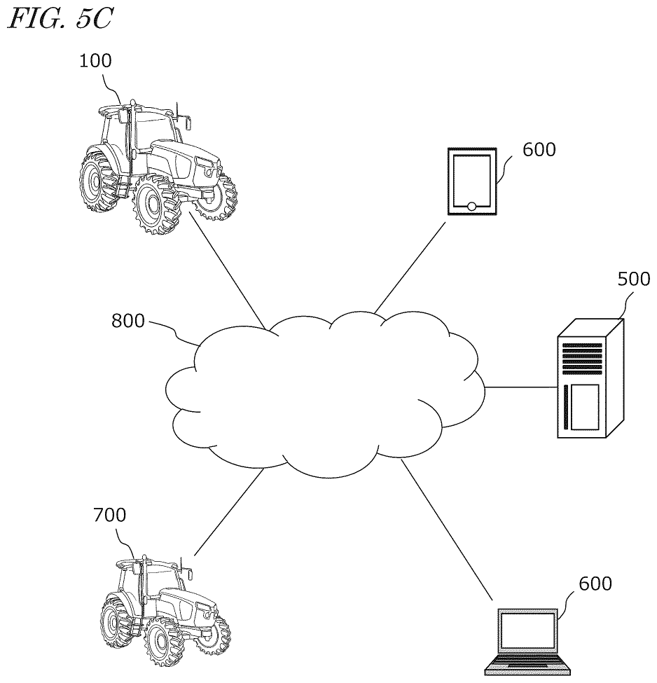

FIG. 6 is a block diagram schematically showing a series of processes of path generation for the work vehicle 100 that may be executed by the processor 530 according to an example embodiment of the present invention. The processor 530 may be configured or programmed to perform processes including information acquisition 51 (i.e., acquiring necessary information), trajectory calculation 52 (i.e., calculating a trajectory of the work vehicle 100 and the implement 300 when the work vehicle 100 has performed a predetermined turn), first space calculation 53 (i.e., calculating a first space), temporary stop position determination 54 (i.e., determining a temporary stop position Pr), and path generation 55 (i.e., generating a path by which the work vehicle 100 travels within the field 70). Based on the information acquired in the information acquisition 51, the process of trajectory calculation 52 is performed. Based on the trajectory that is calculated in the trajectory calculation 52, the process of first space calculation 53 is performed. Based on the first space that is calculated in the first space calculation 53, the process of temporary stop position determination 54 is performed. Based on the temporary stop position Pr that is determined in the temporary stop position determination 54, the process of path generation 55 is performed. In the information acquisition 51, the processor 530 may acquire information from a storage device that is internal or external to the work vehicle 100, or acquire information based on a user input. Although FIG. 6 illustrates examples of information 60 that may be input to the processor 530 in the information acquisition 51, these are merely examples and are not limiting. It is not necessary to acquire all of these pieces of information, and one or more pieces of information (input(s)) may be used in combination. Information (input(s)) other than what is illustrated may further be combined. Specific examples of information 60 may include the size 61 of the work vehicle and the implement, the position relationship 62 between the work vehicle and the implement, the turning direction and turning angle 63, the upper limit value 64 of a tolerable steering angle of the work vehicle, the tolerable traveling direction 65 of the work vehicle, the method of linkage 66 of the implement with the work vehicle, the upper limit value 67 of tolerable articulation angle, and so on. Processes using the respective specific examples of information 60 will be described below.

Details of the process to be performed at each of the steps shown in FIG. 3 and specific examples thereof will be described.

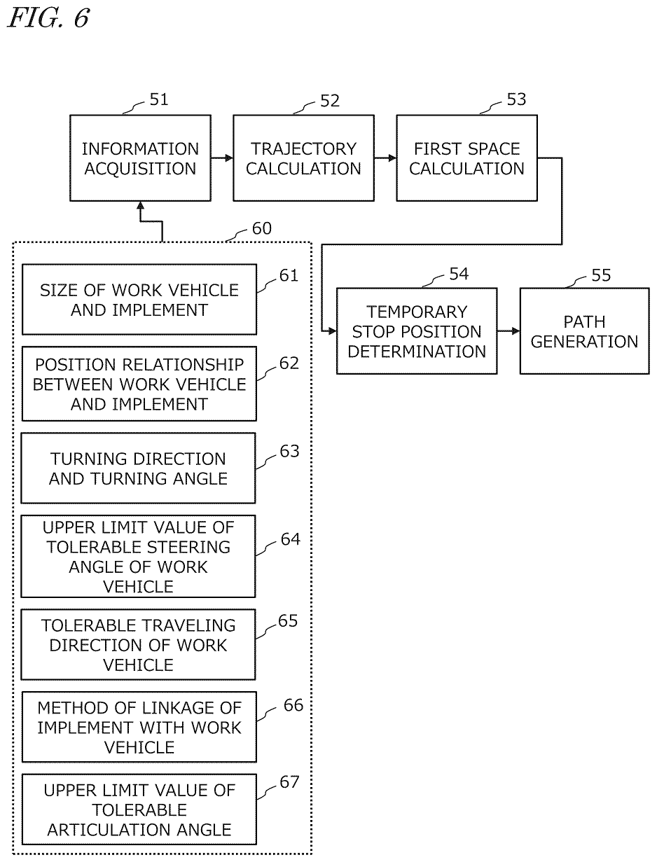

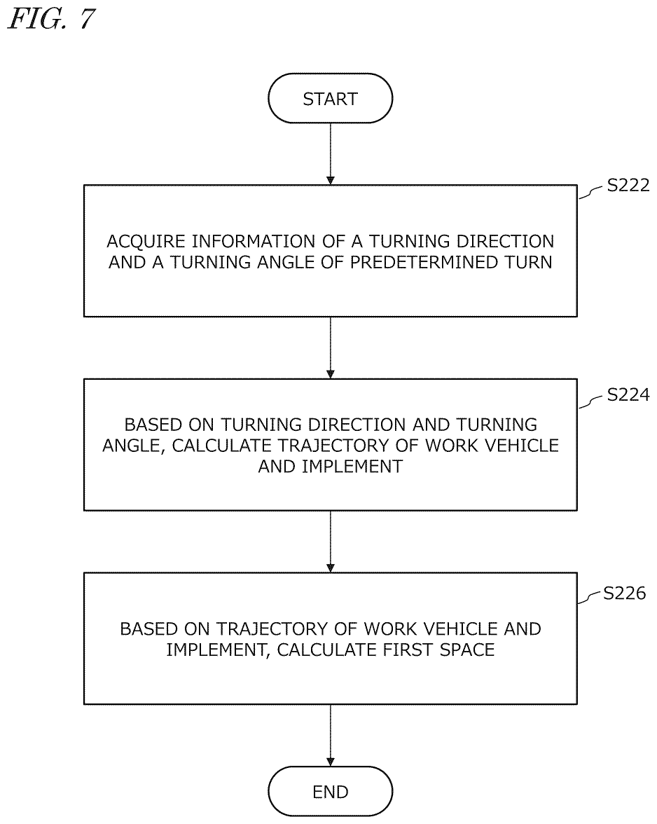

With reference to FIG. 7 and FIG. 8, an example of a process to be performed at step S200 will be described. FIG. 7 is a flowchart showing an example of a process to be performed at step S200. As described above, at step S200, a space that is defined by a trajectory of the work vehicle 100 and the implement 300 when the work vehicle 100 has performed a predetermined turn (which may hereinafter be referred to as a “first space”) is calculated, based on the size of work vehicle 100, the size of the implement 300, and the position relationship between the work vehicle 100 and the implement 300.

FIG. 8 is a schematic diagram for describing an example method of calculating a first space, illustrating how the work vehicle 100 may make a movement from a temporary stop position Pr, through position P0, and to position P1, while turning. It is assumed that the work vehicle 100 completes the turn at position P1. In the example FIG. 8, an implement 300 having wheels 304R is linked to the work vehicle 100 via towing.

As shown in FIG. 7, for example, at step S200, the processes of steps S222, S224 and S226 below may be performed.

At step S222, information of a turning direction and a turning angle of the predetermined turn is acquired. Information of the turning direction includes information as to clockwise or counterclockwise, for example. Information of the turning angle includes information as to the degree by which the orientation of the work vehicle 100 is changed through the predetermined turn, for example. In the example of FIG. 8, the orientation of the work vehicle 100 before the turn (i.e., the orientation of the work vehicle 100 at the temporary stop position Pr) is the −x direction in the figure, the orientation of the work vehicle 100 after the turn (i.e., the orientation of the work vehicle 100 at position P1) is the +y direction in the figure, the turning direction is clockwise, and the turning angle is 90°.

Such information concerning the turn may be acquired based on a user input, or acquired based on sensor data of the surrounding environment of the work vehicle 100 that is acquired while the work vehicle 100 is traveling, for example. The sensor data of the surrounding environment of the work vehicle 100 may be acquired by an external sensor(s) (e.g., camera(s), a LiDAR sensor(s)) that is included in the work vehicle 100, for example. Information concerning the predetermined turn may be acquired based further on terrain data or map data of the field 70 as recorded to a storage device that may be internal or external to the work vehicle 100.

At step S224, based on the information of the turning direction and the turning angle of the predetermined turn as acquired in step S222, a trajectory of the work vehicle 100 and the implement 300 when the work vehicle 100 has performed the predetermined turn is calculated. The trajectory of the work vehicle 100 and the implement 300 may be determined through a simulation, or determined by using a predetermined relational expression or a model expression. The size of the work vehicle 100, the size of the implement 300, and the position relationship between the work vehicle 100 and the implement 300 are also used in the trajectory calculation. The size of the work vehicle 100 includes a length along the front-rear direction and a length (width) along the right-left direction of the work vehicle 100. The size of the implement 300 includes a length along the front-rear direction and a length (width) along the right-left direction of the implement 300. The information of the implement 300 is recorded in a storage device that may be internal or external to the work vehicle 100 in association with information of the type (model) of the implement 300, for example. An example of the trajectory calculation method will be described later.

At step S226, based on the trajectory calculated in step S224, a first space is calculated. In the example of FIG. 8, calculating the first space includes, regarding the trajectory of the work vehicle 100 and the implement 300 when the work vehicle 100 has performed the predetermined turn, determining the following lengths, for example:
a length (which may be referred to as a “first length”) Lf of the trajectory along a direction (which may be referred to as a “first direction”) that is parallel or substantially parallel to the orientation of the work vehicle 100 (−x direction in the figure) before the turn, and
within a length of the trajectory along a direction (which may be referred to as “second direction”) intersecting (e.g., orthogonal to) the first direction, a length (which may be referred to as a “second length”) Ls of a portion of the trajectory that increases in a direction opposite to the direction of the turn, relative to a length along the second direction of the work vehicle 100 before the turn.

The first length Lf is used as a value representing a length, along the traveling direction, that is required for turning. As is illustrated, for example, the first length Lf may be a distance along the first direction from the axle of the rear wheels 104R of the work vehicle 100 before the turn (i.e., the work vehicle 100 at the temporary stop position Pr) to a center line (i.e., a straight connecting the midpoint between the line right and left front wheels 104F and the midpoint between the right and left rear wheels 104R) of the work vehicle 100 after the turn (i.e., the work vehicle 100 at position P1). The second length Ls is used as a value representing a length, along the width direction, of a swell associated with the turn that occurs in the opposite direction to the traveling direction.

At step S400, a temporary stop position Pr is determined based on the first space calculated at step S226. For example, the temporary stop position Pr is determined based on the first length Lf and the second length Ls calculated at step S226.

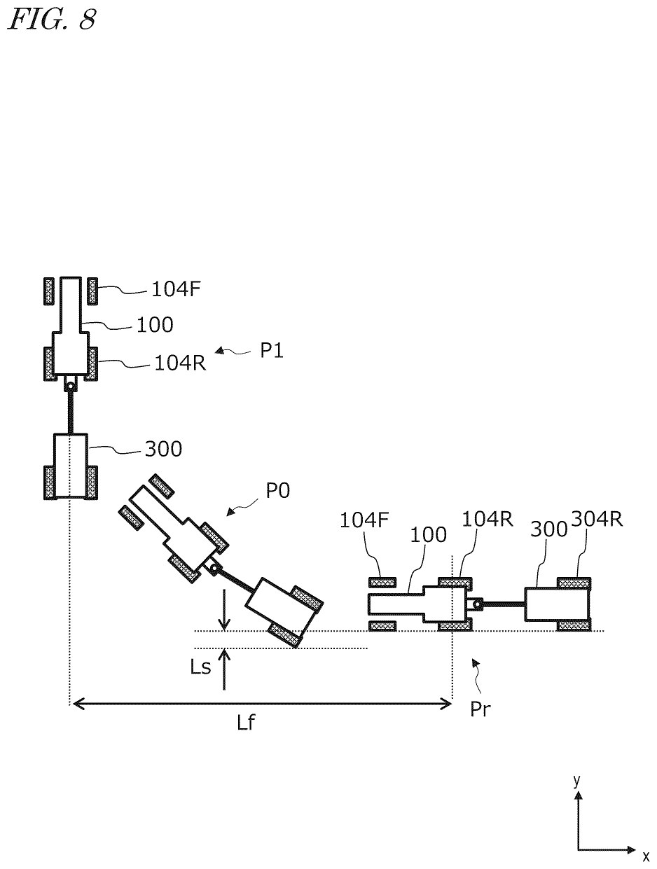

FIG. 9A and FIG. 9B are schematic diagrams for describing an example method of determining the temporary stop position Pr based on the calculated first space. For example, as shown in FIG. 9A, the temporary stop position Pr is determined so that a rectangle 72 that is determined by the first length Lf and the second length Ls is included within the field 70 (i.e., so as not to protrude from the field 70). In the example of FIG. 9B, the rectangle 72 protrudes from the field 70, thus making it impossible to turn within the field 70. As shown in FIG. 9A, by determining the temporary stop position Pr so that the rectangle 72 is included within the field 70, a space for turning is ensured within the field 70. The temporary stop position Pr can be determined as the position of a reference point on the work vehicle 100. The reference point on the work vehicle 100 may be, for example, located on the axle of the rear wheels 104R of the work vehicle 100 and at a midpoint between the right and left rear wheels 104R. In this example, a length 72x of the rectangle 72 along the first direction is equal to the first length Lf. A length 72y of the rectangle 72 along the second direction may be a sum of a maximum value Wv of width (i.e., length along the right-left direction) of the work vehicle 100 having the implement 300 linked thereto, and the second length Ls. The width Wv may be determined by whichever length is greater between the width of the implement 300 and the width of the work vehicle 100. The length 72x of the rectangle 72 along the first direction and the length 72y of the rectangle 72 along the second direction may differ depending on the position of the reference point on the work vehicle 100.

For instance, in the example of FIG. 9A, the temporary stop position Pr is determined so that the rectangle 72 is included in a predetermined region 70P within the peripheral region 70B of the field 70. The predetermined region 70P may be in contact with the outer periphery of the field 70, for example. The predetermined region 70P may be determined, for example, by a position relationship with a vehicle to supply a material. Information of the predetermined region 70P is recorded in a storage device that may be internal or external to the work vehicle 100, for example, and the processor 530 may be configured or programmed to acquire the information of the predetermined region 70P from the storage device. Alternatively, information of the predetermined region 70P may be acquired based on a user input.

In the example of FIG. 9A, the outer periphery of the field 70 includes a plurality of sides (which in this example is a rectangle including four sides). The temporary stop position Pr may be determined so that the temporary stop position Pr is located in a vicinity of one 71a of the plurality of sides of the outer periphery of the field 70 and that the orientation of the work vehicle 100 at the temporary stop position Pr is in a direction that is parallel or substantially parallel to the direction in which the side 71a extends (which in this example is the x direction). Because the work vehicle 100 at the temporary stop position Pr is located in a vicinity of side 71a of the outer periphery of the field 70 and the orientation of the work vehicle 100 at the temporary stop position Pr is in a direction that is parallel or substantially parallel to the side 71a, it may become easier to supply the material. In other words, the work involved in supplying the material can be efficiently performed.

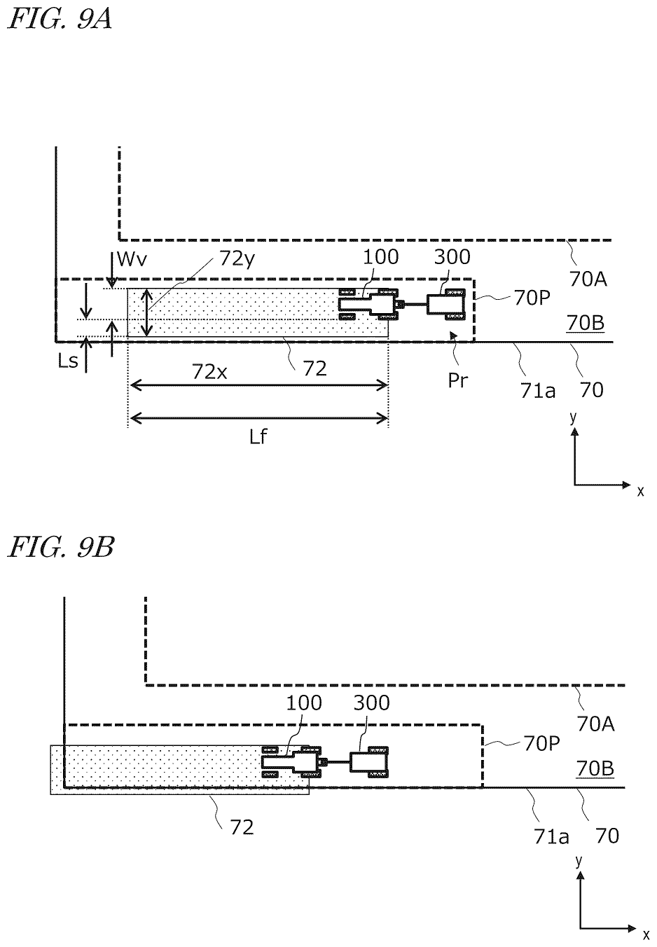

With reference to FIG. 10 to FIG. 13, other examples of the calculation method for the trajectory of the work vehicle 100 and the implement 300 will be described. Any two or more of the calculation methods which will be described with reference to FIG. 10 to FIG. 13 and the calculation method which has been described with reference to FIG. 7 can be used in combination.

FIG. 10 is a flowchart showing another example of a process to be performed at step S200. The flowchart of FIG. 10 differs from the flowchart of FIG. 7 in that, instead of step S222 and step S224, it includes step S222a and step S224a.

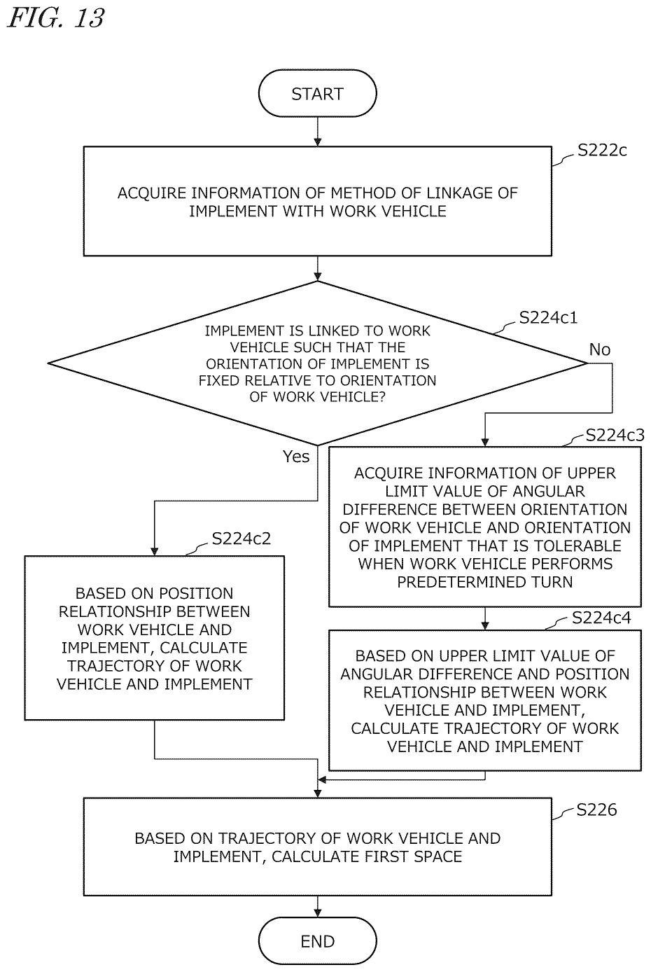

At step S222a, information of an upper limit value of steering angle of the work vehicle 100 that is tolerable when the work vehicle 100 performs a predetermined turn is acquired. Information of the upper limit value of the tolerable steering angle may be acquired based on a user input, for example. For instance, the user may set an upper limit value of steering angle that achieves a control of the implement 300 with a predetermined precision or above during a turn. The upper limit value of steering angle that has been input by the user may be compared against a maximum steering angle in a scenario where the work vehicle 100 having the implement 300 linked thereto performs steady-state circular turning (i.e., a steering angle that enables a turning with the smallest turning radius), and whichever one of them is the smaller may be used as the upper limit value of the tolerable steering angle. The maximum steering angle may be determined through a simulation, or determined by using a predetermined relational expression (e.g., equation (d)) in FIG. 14 described below).

As another example, the upper limit value of the tolerable steering angle may be previously set in accordance with the size of the implement 300 or the method of linkage. In such cases, information of the upper limit value of the tolerable steering angle may be recorded in a storage device that may be internal or external to the work vehicle 100 as data that is associated with the type (model) of the implement 300 (e.g., a table). Alternatively, based on terrain data or map data of the field 70, the upper limit value of the tolerable steering angle may be determined in accordance with the shape of the field 70, for example. The terrain data or map data of the field 70 is recorded in a storage device that may be internal or external to the work vehicle 100, for example.

At step S224a, based on the upper limit value of steering angle acquired in step S222a, a trajectory of the work vehicle 100 and the implement 300 when the work vehicle 100 has performed the predetermined turn is calculated. For example, the trajectory of the work vehicle 100 and the implement 300 may be calculated on the assumption that the steering angle of the work vehicle 100 is fixed to a certain value that is equal to or less than the upper limit value. By calculating the trajectory while setting the upper limit value of the tolerable steering angle, control of the implement 300 can be achieved with a good precision during a turn. In particular, a noticeable effect can be obtained in the case of a towing type implement 300.

At step S226, based on the trajectory calculated in step S224a, a first space is calculated. The process of step S226 may be performed similarly to step S226 in the flowchart of FIG. 7.

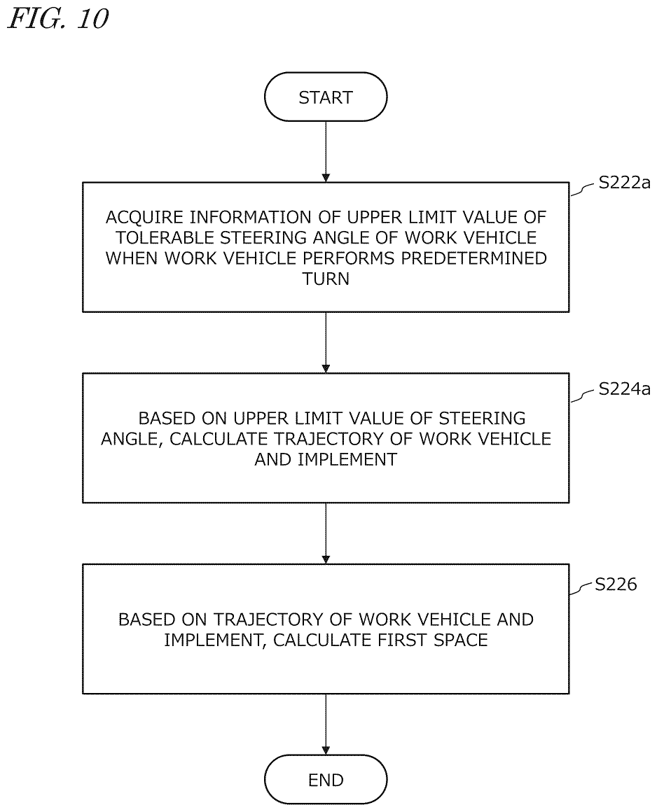

FIG. 11 is a flowchart showing another example of a process to be performed at step S200. The flowchart of FIG. 11 differs from the flowchart of FIG. 7 in that, instead of step S222 and step S224, it includes step S222b and step S224b.

At step S222b, during travel of the work vehicle 100 along the connection path PP3 that connects the temporary stop position Pr and the work restart position 30I2 in the work area 70A after stopping at the temporary stop position Pr, information of one or more tolerable motions (traveling direction(s)) selected from among forward travel, backward travel, right turn, and left turn motions is acquired. For instance, in the example shown in FIG. 8, forward travel and right turn motions are tolerable. Information of tolerable motions may be acquired based on a user input, for example.

At step S224b, based on the one or more tolerable motions acquired at step S222b, a trajectory of the work vehicle 100 and the implement 300 when the work vehicle 100 has performed the predetermined turn is calculated. In other words, based only on one or more tolerable motions, a trajectory of the work vehicle 100 and the implement 300 in the case of performing a predetermined turn that is defined by the turning direction and the turning angle is calculated. When the implement 300 is linked to the work vehicle 100, and particularly when the implement 300 is linked to the work vehicle 100 via towing, there may be cases where control of the implement 300 is not easy during backward travel of the work vehicle 100. By calculating a trajectory of the turn based on a tolerable motion(s), the temporary stop position Pr can be determined in such a manner that travel is possible without involving any backward travel before and after the temporary stop position Pr, for example. The user can designate a motion(s) (traveling direction(s)) of the work vehicle 100 to be avoided before and after the temporary stop position Pr.

At step S226, based on the trajectory calculated in step S224b, a first space is calculated. The process of step S226 may be performed similarly to step S226 in the flowchart of FIG. 7.

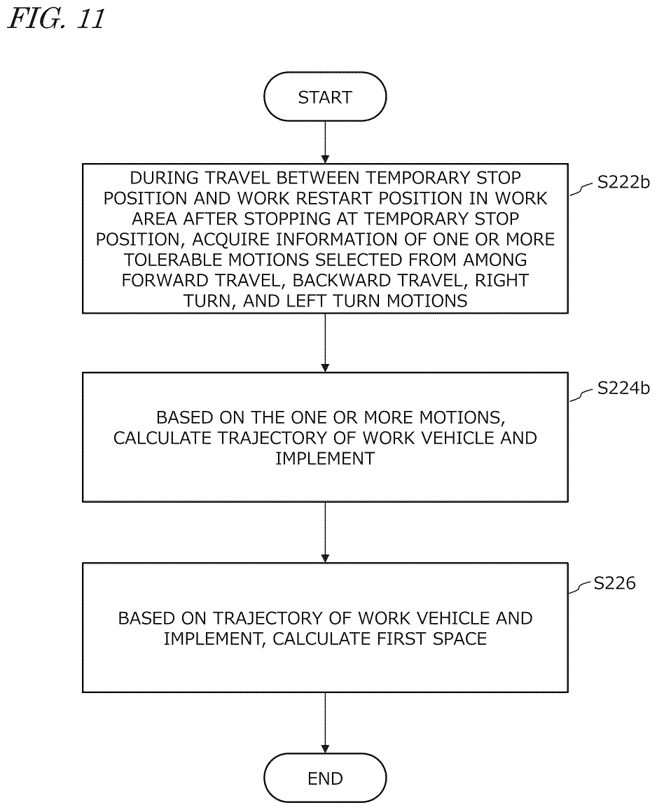

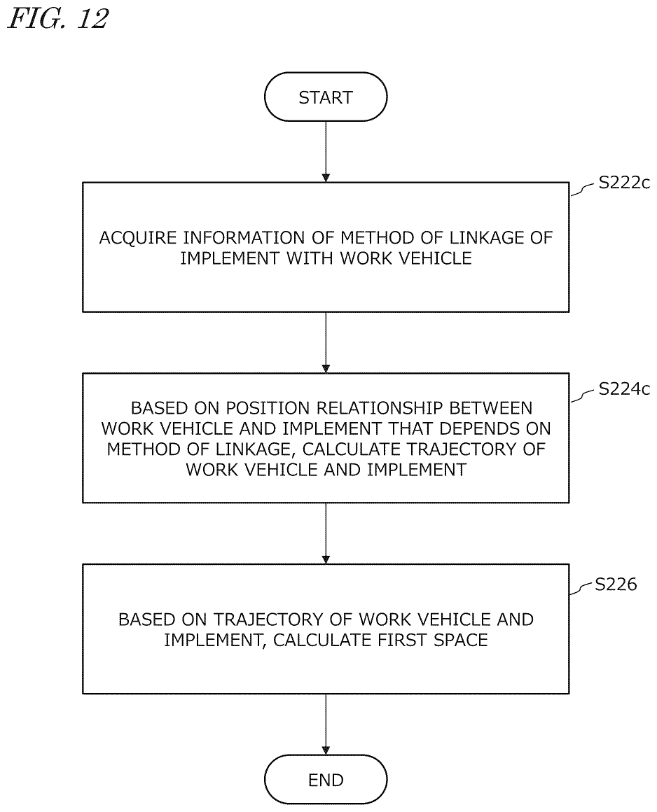

FIG. 12 and FIG. 13 are flowcharts showing other examples of the process to be performed at step S200. The flowchart of FIG. 12 differs from the flowchart of FIG. 7 in that, instead of step S222 and step S224, it includes step S222c and step S224c. The flowchart of FIG. 13 differs from the flowchart of FIG. 12 in that it includes steps S224c1 to S224c4 as the process to be performed at step S224c.

At step S222c, information of the method of linkage of the implement 300 with the work vehicle 100 is acquired. Information of the method of linkage of the implement 300 with the work vehicle 100 includes information as to via direct mounting or via towing, for example. The information of the method of linkage of the implement 300 with the work vehicle 100 may be recorded in a storage device that may be internal or external to the work vehicle 100 as data (e.g., a table) that is associated with the type (model) of the implement 300.

At step S224c, based on the position relationship between the work vehicle 100 and the implement 300 that depends on the method of linkage of the implement 300 with the work vehicle 100 as acquired in step S222c, a trajectory of the work vehicle 100 and the implement 300 when the work vehicle 100 has performed the predetermined turn is calculated. Specifically, the processes of steps S224c1 to 224c4 shown in FIG. 13 are performed, for example.

At step S224c1, based on the information acquired in step S222c, it is determined whether the method of linkage of the implement 300 with the work vehicle 100 dictates that the implement 300 is linked to the work vehicle 100 such that the orientation of the implement 300 is fixed relative to the orientation of the work vehicle 100. For example, if the implement 300 is linked to the work vehicle 100 via direct mounting, the orientation of the implement 300 is fixed relative to the orientation of the work vehicle 100, so control proceeds to “Yes”, on the other hand, if the implement 300 is linked to the work vehicle 100 via towing, the orientation of the implement 300 is not fixed relative to the orientation of the work vehicle 100, so control proceeds to “No”.

If step S224c1 finds “Yes”, control proceeds to step S224c2, where, based on the position relationship between the work vehicle 100 and the implement 300, a trajectory of the work vehicle 100 and the implement 300 when the work vehicle 100 has performed the predetermined turn is calculated.

If step S224c1 finds “No”, control proceeds to step S224c3, where information of an upper limit value of an angular difference between the orientation of the work vehicle 100 and the orientation of the implement 300 (i.e., angle β in FIG. 14 as described below) that is tolerable when the work vehicle 10 performs a predetermined turn is acquired. The angular difference between the orientation of the work vehicle 100 and the orientation of the implement 300 may also be referred to as an “articulation angle”. Information of the upper limit value of tolerable articulation angle may be acquired based on a user input, for example. For instance, the user may set an upper limit value of articulation angle that achieves a control of the towing type implement 300 with a predetermined precision or above during a turn. At step S224c4, based on the position relationship between the work vehicle 100 and the implement 300 and the upper limit value of the angular difference acquired at step S224c3, a trajectory of the work vehicle 100 and the implement 300 when the work vehicle 100 has performed the predetermined turn is calculated.

At step S226, based on the trajectory calculated in step S224c2 or step S224c4, a first space is calculated. The process of step S226 may be performed similarly to step S226 in the flowchart of FIG. 7.

With reference to FIG. 14, an example method of calculating a trajectory of the work vehicle 100 and the implement 300 will be described. FIG. 14 is a schematic top view for describing a position relationship between the work vehicle 100 and the implement 300 linked to the work vehicle 100 via towing. Respective symbols in FIG. 14 represent the following.
l₁: distance between the axle of the front wheels 104F and the axle of the rear wheels 104R of the work vehicle 100
l₂: distance between the position at which the work vehicle 100 and the implement 300 are connected and the axle of the rear wheels 304R of the implement 300
h: distance between the axle of the rear wheels 104R of the work vehicle 100 and the position at which the work vehicle 100 and the implement 300 are connected
point A: center of the axle of the front wheels 104F of the work vehicle 100
point B: center of the axle of the rear wheels 104R of the work vehicle 100
point C: position at which the work vehicle 100 and the implement 300 are connected
point D: center of the axle of the wheels 304R of the implement 300
θ₁: orientation of the work vehicle 100
θ₂: orientation of the implement 300
α: steering angle (rad)
β: angular difference (articulation angle) between the orientation of the work vehicle 100 and the orientation of the implement 300 (rad)
x coordinate and y coordinate of point B will be designated as (x₁, y₁), and x coordinate and y coordinate of point D as (x₂, y₂), respectively.

For example, in the calculation of the trajectory of the work vehicle 100 and the implement 300, equation (a) to equation (c) can be used. Equation (a) to equation (c) are equations relating to motions of the work vehicle 100 and the implement 300 during forward travel at an extremely low constant speed V(m/s), given a fixed value of steering angle α. Equation (a) is an equation relating to a motion of the work vehicle 100. Equation (b), which includes equation (b1) and equation (b2), is an equation relating to a motion of the implement 300 being linked to the work vehicle 100 via direct mounting. Equation (c), which includes equation (c1) and equation (c2), is an equation relating to a motion of the implement 300 being linked to the work vehicle 100 via towing. An extremely low speed corresponds to a vehicle speed at which sideways skid is negligible. When determining the trajectory of the work vehicle 100 and the implement 300 by using equation (a) to equation (c), the vehicle speed of the work vehicle 100 is preferably, e.g., about 0.5 m/s (e.g., about 0.5 meters per second) or less, and more preferably about 0.2 m/s (e.g., about 0.2 meters per second)) or less. Details of equation (a) to equation (c) are described in Ryo Torisu et al., “Fundamental Equations Describing the Motion of Coupled Vehicles at Extremely Low Speeds,” Journal of the Society of Agricultural Machinery, 52(5), pages 27 to 34 (1990).

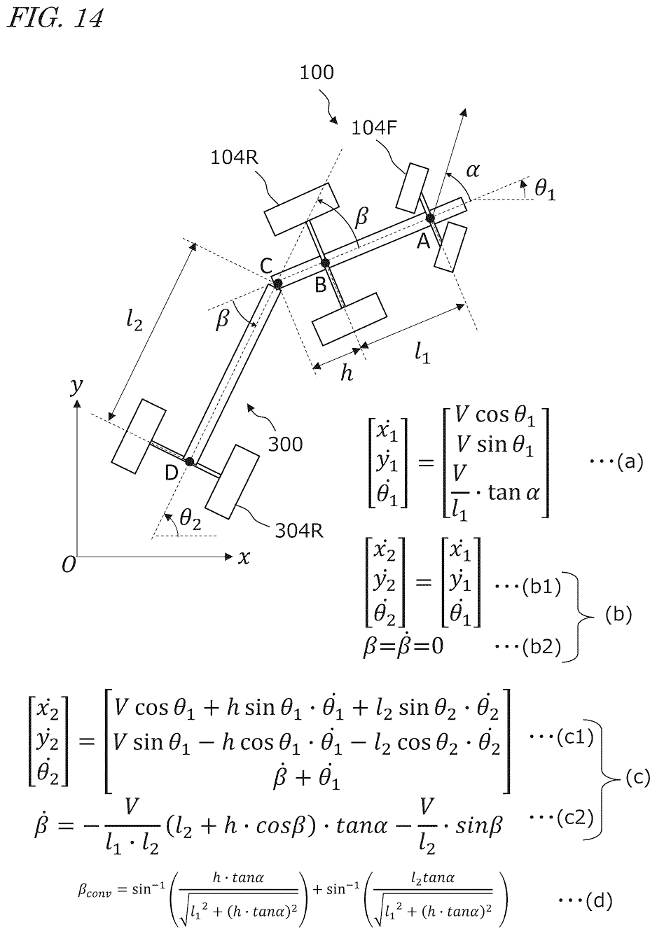

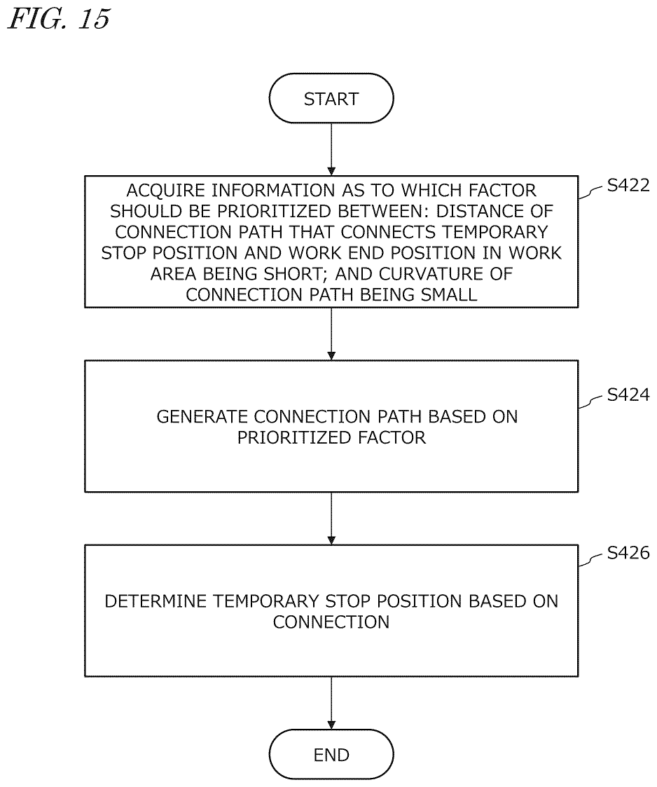

With reference to FIG. 15 and FIG. 16, an example of a process (determination of a temporary stop position) that may be performed at step S400 will be described. FIG. 15 is a flowchart showing an example of a process to be performed at step S400. As described above, at step S400, based on the first space calculated in step S200, a temporary stop position Pr is determined. FIG. 16 is a schematic diagram for describing an example method of determining the temporary stop position Pr.

As shown in FIG. 16, a plurality of alternatives may exist for the temporary stop position Pr. In the example of FIG. 16, position Pra and position Prb are shown as candidates of temporary stop positions Pr. It is assumed that each of position Pra and position Prb can be derived based on the first space calculated in step S200. In other words, regardless of whether position Pra or position Prb is the temporary stop position, a space for turning is ensured (i.e., in the illustrated example, a rectangle that is determined by the first length Lf and the second length Ls will fit within the predetermined region 70P of the field 70). Let path PP2a and path PP2b, respectively, be designated as candidates of connection paths PP2 corresponding to candidates of temporary stop positions Pr (i.e., position Pra and position Prb). Although two positions Pra and Prb are depicted as candidates of temporary stop positions Pr for simplicity, there may be three or more candidates of temporary stop positions Pr and their corresponding paths. Candidates of temporary stop positions Pr are not limited to being a plurality of discrete points, and such positions may be contiguously present within a region having a finite area.

As shown in FIG. 15, at step S400, the processes of steps S422, S424 and S426 may be performed.

At step S422, information is acquired as to which factor should be prioritized between the distance of the connection path PP2 (that connects the temporary stop position Pr and the work end position 30I1 in the work area 70A before stopping at the temporary stop position Pr) being short, and the curvature of the connection path PP2 being small. The user may make an input indicating which factor should be prioritized, and based on the user input, information of the prioritized factor may be acquired. Alternatively, based on terrain data or map data of the field 70, information of the prioritized factor may be acquired.

At step S424, based on the prioritized factor acquired in step S422, the connection path PP2 is generated. For instance, in the example of FIG. 16, the connection path PP2b is generated if the connection path PP2 being short is prioritized, and the connection path PP2a is generated if the curvature of the connection path PP2 being small is prioritized.

At step S426, based on the connection path PP2 generated in step S424, the temporary stop position Pr is determined. For instance, in the example of FIG. 16, if the connection path PP2b is generated, then a temporary stop position Prb is generated, and if the connection path PP2a is generated, then a temporary stop position Pra is determined. Thus, based on the prioritized factor that is set by the user, for example, the temporary stop position Pr can be selected from among the plurality of alternatives. If the connection path PP2 being short is prioritized, the travel time of the work vehicle 100 can be shortened. If the curvature of the connection path PP2 being small is prioritized, it is possible to restrain the ground surface of the field 70 from becoming rough due to travel of the work vehicle 100, thus suppressing impact on the ground surface of the field 70.

In a case where a plurality of alternatives exist for the temporary stop position Pr, a temporary stop position Pr may be determined based on information as to which factor should be prioritized between the distance of the connection path PP3 (that connects the temporary stop position Pr and the work restart position 30I2 in the work area 70A after stopping at the temporary stop position Pr) being short, and the curvature of the connection path PP3 being small.

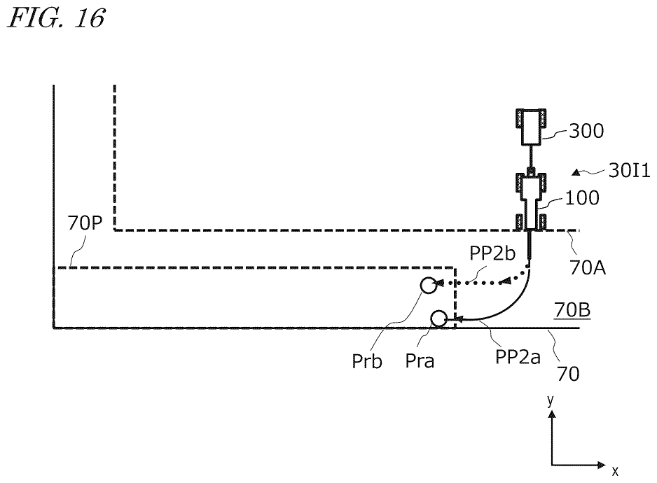

FIG. 17 is a schematic side view of a work vehicle 100 having another implement 300a linked thereto. To the work vehicle 100 shown in FIG. 17, a front loader 300a is linked as an implement to the front of the work vehicle 100. The front loader 300a is linked to the work vehicle 100 via direct mounting.

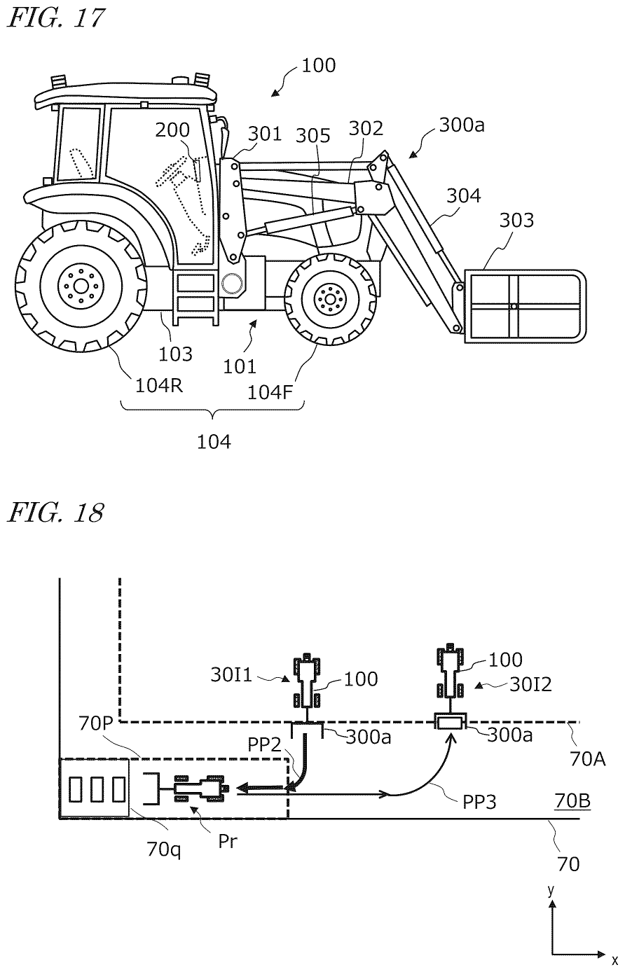

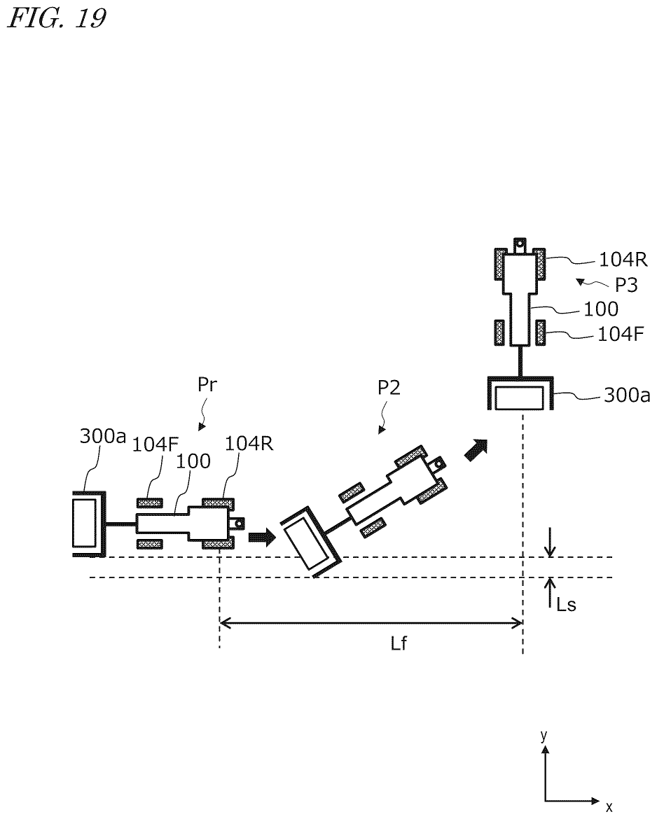

With reference to FIG. 18 and FIG. 19, an example method of calculating a first space in the example of FIG. 17 will be described. FIG. 18 and FIG. 19 are schematic diagrams for describing an example calculation method of a first space. FIG. 18 illustrates the work vehicle 100 with the implement 300a linked thereto being located at a work end position 30I1 in a work area 70A before stopping at a temporary stop position Pr, the work vehicle 100 being located at the temporary stop position Pr, and the work vehicle 100 being located at a work restart position 30I2 in the work area 70A after stopping at the temporary stop position Pr. In this example, a material storage area 70q is provided in a predetermined region 70P of the within the field 70, at which the material to be carried by the implement 300a is to be supplied. In a connection path PP2 from the work end position 30I1 to the temporary stop position Pr, the traveling direction of the work vehicle 100 includes forward travel and a right turn. On the other hand, in a connection path PP3 from the temporary stop position Pr to the work restart position 30I2, the traveling direction (motion) of the work vehicle 100 includes backward travel.

As shown in FIG. 19, in the example of FIG. 18, too, the first space can be calculated by determining a first length Lf and a second length Ls of a trajectory of the work vehicle 100 and the implement 300 when the work vehicle 100 has performed the predetermined turn, similarly to the example of FIG. 8. The example of FIG. 19 illustrates how the work vehicle 100 may perform backward travel from the temporary stop position Pr, through position P2, and to position P3, while turning. It is assumed that the work vehicle 100 completes the turn at position P3. In the example of FIG. 19, the orientation of the work vehicle 100 before the turn (i.e., the orientation of the work vehicle 100 at the temporary stop position Pr) is the −x direction in the figure, the orientation of the work vehicle 100 after the turn (i.e., the orientation of the work vehicle 100 at position P1) is the −y direction in the figure, the turning direction is counterclockwise, and the turning angle is 90°.

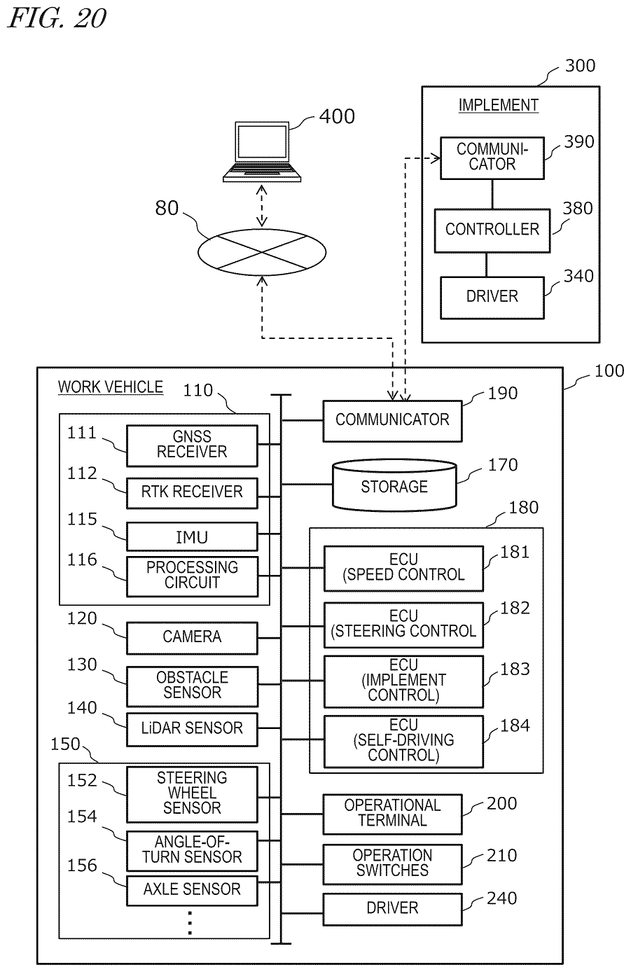

FIG. 20 is a block diagram schematically showing an example configuration for the work vehicle 100 and the implement 300. With reference also to FIG. 1, the configuration of the work vehicle 100 and the implement 300 will be described. As for the work vehicle 100 having the front loader 300a linked thereto, shown in FIG. 17, description will be omitted with respect to any aspects that are common to the example of FIG. 1.

As shown in in FIG. 1 and FIG. 20, the work vehicle 100 includes a positioning device 110 to output position data concerning the position of the work vehicle 100 (e.g., a GNSS unit), a sensor group 150 to detect the state of the work vehicle 100 and output sensor data, and a controller 180 to control the operation of the work vehicle 100. The sensor group 150 includes one or more sensors.

The work vehicle 100 may further include a plurality of external sensors to sense the surroundings of the work vehicle 100. An “external sensor” is a sensor that senses the external state of the work vehicle. In the example of FIG. 1, the external sensors include a plurality of LiDAR sensors 140, a plurality of cameras 120, and a plurality of obstacle sensors 130.

In addition to the positioning device 110, the cameras 120, the obstacle sensors 130, the LiDAR sensors 140, the sensor group 150, a storage device 170, the controller 180, and an operation terminal 200, the work vehicle 100 in the example of FIG. 20 also includes a communicator 190, operation switches 210, and a driver 240 (which may be referred to as a “first driver”). These component elements are communicably connected to one another via a bus.

As shown in FIG. 1, the work vehicle 100 includes a vehicle body 101, a prime mover (engine) 102, and a transmission 103. On the vehicle body 101, travel device, which includes wheels 104 with tires, and a cabin 105 are provided. The travel device includes four wheels 104, and axles to cause the four wheels to rotate, and braking device (brakes) to brake on each axle. The wheels 104 include a pair of front wheels 104F and a pair of rear wheels 104R. Inside the cabin 105, a driver's seat 107, a steering device 106, an operation terminal 200, and switches for manipulation are provided. The front wheels 104F and/or the rear wheels 104R may be replaced by a plurality of wheels with a track (crawlers), rather than wheels with tires, attached thereto.

The prime mover 102 may be a diesel engine, for example. Instead of a diesel engine, an electric motor may be used. The transmission 103 can change the propulsion and the moving speed of the work vehicle 100 through a speed changing mechanism. The transmission 103 can also switch between forward travel and backward travel of the work vehicle 100.

The steering device 106 includes a steering wheel, a steering shaft connected to the steering wheel, and a power steering device to assist in the steering by the steering wheel. The front wheels 104F are the wheels responsible for steering, such that changing their angle of turn (also referred to as “steering angle”) can cause a change in the traveling direction of the work vehicle 100. The steering angle of the front wheels 104F can be changed by manipulating the steering wheel. The power steering device includes a hydraulic device or an electric motor to supply an assisting force for changing the steering angle of the front wheels 104F. When automatic steering is performed, under the control of the controller included in the work vehicle 100, the steering angle may be automatically adjusted by the power of the hydraulic device or the electric motor.

A linkage device 108 is provided at the rear of the vehicle body 101. The linkage device 108 includes, e.g., a three-point linkage (also referred to as a “three-point hitch” or a “three-point link”), a PTO (Power Take Off) shaft, a universal joint, and a communication cable. The linkage device 108 allows the implement 300 to be attached to, or detached from, the work vehicle 100. The linkage device 108 is able to raise or lower the three-point hitch with a hydraulic device, for example, thus changing the position or attitude of the implement 300. Moreover, motive power can be sent from the work vehicle 100 to the implement 300 via the universal joint. While towing the implement 300, the work vehicle 100 allows the implement 300 to perform a predetermined task. The linkage device may be provided at the front portion of the vehicle body 101. In that case, the implement can be connected at the front portion of the work vehicle 100.

Although the implement 300 shown in FIG. 1 is a sprayer to spray a chemical agent onto a crop, the implement 300 is not limited to a sprayer. For example, any arbitrary task device such as a mower, a seeder, a spreader, a rake, a baler, a harvester, a plow, a harrow, or a rotary tiller may be connected to the work vehicle 100 for use.

The front loader 300a shown in FIG. 17, as an example implement, includes a support frame 301, a boom 302, a front attachment (which in this example is a bale grab) 303, a cylinder 304, and boom cylinders 305. The support frame 301 is fixed to the frame of the vehicle body 101. The boom 302 has an arm structure, and is rotatably supported by the support frame 301 so as to extend frontward and above from the vehicle. The front attachment 303 is rotatably supported by an end of the boom 302. The front loader 300a is linked to the vehicle body 101 via a hydraulic coupler and a power connector. The front loader 300a includes a hydraulic system including hydraulic valves, and operates under hydraulic control. Specifically, by extending or retracting the boom cylinders 305 via hydraulic action, the boom 302 can be rotated around a rotation axis that is located at the boom fulcrum. As a result, the front loader 300a (or the front attachment 303) can be raised or lowered.

Referring back to FIG. 1, the positioning device 110 receives satellite signals (also referred to as GNSS signals) that are transmitted from a plurality of GNSS satellites, and performs positioning based on the satellite signals. GNSS is a collective term for satellite positioning systems such as the GPS (Global Positioning System), QZSS (Quasi-Zenith Satellite System, e.g., MICHIBIKI), GLONASS, Galileo, and BeiDou. Although the positioning device 110 in the present example embodiment is located above the cabin 105, it may be located at any other position.

As shown in FIG. 20, the positioning device 110 includes a GNSS receiver 111, an RTK receiver 112, and a processing circuit 116. The positioning device 110 may further include an inertial measurement unit (IMU) 115.

The GNSS receiver 111 includes an antenna to receive signals from the GNSS satellites, and a processing circuit to determine the position of the work vehicle 100 based on the signals received by the antenna. The GNSS receiver 111 in the GNSS unit 110 receives satellite signals transmitted from the plurality of GNSS satellites and generates GNSS data based on the satellite signals. The GNSS data is generated in a predetermined format such as, for example, the NMEA-0183 format. The GNSS data may include, for example, the ID number, the angle of elevation, the azimuth angle, and a value representing the reception intensity of each of the satellites from which the satellite signals are received.

The positioning device 110 may perform positioning of the work vehicle 100 by utilizing an RTK (Real Time Kinematic)-GNSS. In the positioning based on the RTK-GNSS, not only satellite signals transmitted from a plurality of GNSS satellites, but also a correction signal that is transmitted from a reference station is used. The reference station may be located in a vicinity of work area where the work vehicle 100 performs tasked travel (e.g., at a position within about 10 km of the work vehicle 100). The reference station generates a correction signal of, for example, an RTCM format based on the satellite signals received from the plurality of GNSS satellites, and transmits the correction signal to the positioning device 110. The RTK receiver 112, which includes an antenna and a modem, receives the correction signal transmitted from the reference station. Based on the correction signal, the processing circuit 116 of the positioning device 110 corrects the results of the positioning performed by the GNSS receiver 111. Use of the RTK-GNSS enables positioning with an accuracy on the order of several centimeters of errors, for example. Positional information including latitude, longitude, and altitude information is acquired through the highly accurate positioning by the RTK-GNSS. The positioning device 110 calculates the position of the work vehicle 100 as frequently as, for example, one to ten times per second. Note that the positioning method is not limited to being performed by using an RTK-GNSS, any arbitrary positioning method (e.g., an interferometric positioning method or a relative positioning method) that provides positional information with the necessary accuracy can be used. For example, positioning may be performed by utilizing a VRS (Virtual Reference Station) or a DGPS (Differential Global Positioning System).

The positioning device 110 according to the present example embodiment may further include the IMU 115. With the inclusion of the IMU 115, the positioning device 110 can complement position data by utilizing signals from the IMU 115. The data acquired by the IMU 115 can be used to complement the position data based on the satellite signals, so as to improve the performance of positioning.

The IMU 115 may include a 3-axis accelerometer and a 3-axis gyroscope. The IMU 115 may include a direction sensor such as a 3-axis geomagnetic sensor. The IMU 115 functions as a motion sensor which can output signals representing parameters such as acceleration, velocity, displacement, and attitude of the work vehicle 100. Based not only on the satellite signals and the correction signal but also on a signal that is output from the IMU 115, the processing circuit 116 can estimate the position and orientation of the work vehicle 100 with a higher accuracy. The signal that is output from the IMU 115 may be used for the correction or complementation of the position that is calculated based on the satellite signals and the correction signal. The IMU 115 outputs a signal more frequently than the GNSS receiver 111. For example, the IMU 115 outputs a signal as frequently as approximately several ten times to several thousand times per second. Utilizing this signal that is output highly frequently, the processing circuit 116 allows the position and orientation of the work vehicle 100 to be measured more frequently (e.g., about 10 Hz or above). Instead of the IMU 115, a 3-axis accelerometer and a 3-axis gyroscope may be separately provided. The IMU 115 may be provided as a separate device from the positioning device 110.

The sensor group 150 may include various sensors to detect the state of the work vehicle 100 or the implement 300 (i.e., internal sensors). For example, the sensor group 150 may include a steering wheel sensor 152, an angle-of-turn sensor 154, and an axle sensor 156.

The steering wheel sensor 152 measures the angle of rotation of the steering wheel of the work vehicle 100. The angle-of-turn sensor 154 measures the angle of turn of the front wheels 104F, which are the wheels responsible for steering. Measurement values by the steering wheel sensor 152 and the angle-of-turn sensor 154 may be used for steering control by the controller 180.

The axle sensor 156 measures the rotational speed, i.e., the number of revolutions per unit time, of an axle that is connected to the wheels 104. The axle sensor 156 may be a sensor including a magnetoresistive element (MR), a Hall generator, or an electromagnetic pickup, for example. The axle sensor 156 outputs a numerical value indicating the number of revolutions per minute (unit: rpm) of the axle, for example. The axle sensor 156 is used to measure the speed of the work vehicle 100. Measurement values from the axle sensor 156 can be utilized for the speed control by the controller 180.

The storage device 170 includes one or more storage media such as a flash memory or a magnetic disc. The storage device 170 stores various data that is generated by the positioning device 110, the cameras 120, the obstacle sensors 130, the LiDAR sensors 140, the sensor group 150, and the controller 180. The data that is stored by the storage device 170 may include an environment map of the environment where the work vehicle 100 travels, an obstacle map that is consecutively generated during travel, and path data for self-driving. The storage device 170 also stores a computer program(s) to cause each of the ECUs in the controller 180 to perform various operations described below. Such a computer program(s) may be provided to the work vehicle 100 via a storage medium (e.g., a semiconductor memory, an optical disc, etc.) or through telecommunication lines (e.g., the Internet). Such a computer program(s) may be marketed as commercial software.

The controller 180 includes the plurality of ECUs. The plurality of ECUs include, for example, the ECU 181 for speed control, the ECU 182 for steering control, the ECU 183 for implement control, and the ECU 184 for self-driving control.

The ECU 181 is configured or programmed to control the prime mover 102, the transmission 103, and brakes included in the driver 240, thus controlling the speed of the work vehicle 100.

The ECU 182 is configured or programmed to control the hydraulic device or the electric motor included in the steering device 106 based on a measurement value of the steering wheel sensor 152, thus controlling the steering of the work vehicle 100.

In order to cause the implement 300 to perform a desired operation, the ECU 183 is configured or programmed to control the operations of the three-point hitch, the PTO shaft, and the like that are included in the linkage device 108. Also, the ECU 183 is configured or programmed to generate a signal to control the operation of the implement 300, and transmit this signal from the communicator 190 to the implement 300.

Based on data output from the positioning device 110, the cameras 120, the obstacle sensors 130, the LiDAR sensors 140, and the sensor group 150, the ECU 184 is configured or programmed to perform computation and control for achieving self-driving. For example, the ECU 184 is configured or programmed to estimate the position of the work vehicle 100 based on the data output from at least one of the positioning device 110, the cameras 120, and the LiDAR sensors 140. In a situation where a sufficiently high reception intensity exists for the satellite signals from the GNSS satellites, the ECU 184 may determine the position of the work vehicle 100 based only on the data output from the positioning device 110. On the other hand, in an environment where obstructions, such as trees, that may hinder reception of the satellite signals exist around the work vehicle 100, e.g., an orchard, the ECU 184 estimates the position of the work vehicle 100 by using the data output from the LiDAR sensors 140 or the cameras 120. During self-driving, the ECU 184 performs computation necessary for the work vehicle 100 to travel along a target path, based on the estimated position of the work vehicle 100. The ECU 184 is configured or programmed to send the ECU 181 a command to change the speed, and sends the ECU 182 a command to change the steering angle. In response to the command to change the speed, the ECU 181 is configured or programmed to control the prime mover 102, the transmission 103, or the brakes to change the speed of the work vehicle 100. In response to the command to change the steering angle, the ECU 182 is configured or programmed to control the steering device 106 to change the steering angle.

Through the actions of these ECUs, the controller 180 is configured or programmed to realize self-traveling. During self-traveling, the controller 180 is configured or programmed to control the driver 240 based on the measured or estimated position of the work vehicle 100 and on the consecutively-generated target path. As a result, the controller 180 can cause the work vehicle 100 to travel along the target path.

The plurality of ECUs included in the controller 180 can communicate with one another in accordance with a vehicle bus standard such as, for example, a CAN (Controller Area Network). Instead of a CAN, faster communication methods such as Automotive Ethernet (registered trademark) may be used. Although the ECUs 181 to 184 are illustrated as individual blocks in FIG. 20, the function of each of the ECU 181 to 184 may be implemented by a plurality of ECUs. Alternatively, an onboard computer that integrates the functions of at least some of the ECUs 181 to 184 may be provided. The controller 180 may include ECUs other than the ECUs 181 to 184, and any number of ECUs may be provided in accordance with functionality. Each ECU includes a processing circuit including one or more processors.

The cameras 120 may be provided at the front/rear/right/left of the work vehicle 100, for example. The cameras 120 image the surrounding environment of the work vehicle 100 and generate image data. The images acquired with the cameras 120 may be transmitted to the terminal device, which is responsible for remote monitoring, for example. The images may be used to monitor the work vehicle 100 during unmanned driving. The cameras 120 may be provided according to the needs, and any number of them may be provided.

The LiDAR sensors 140 are one example of external sensors that output sensor data indicating a distribution of geographic features around the work vehicle 100. In the example of FIG. 1, two LiDAR sensors 140 are disposed on the cabin 105, at the front and the rear. The LiDAR sensors 140 may be provided at other positions (e.g., on a lower portion of a front face of the vehicle body 101). While the work vehicle 100 is traveling, each LiDAR sensor 140 repeatedly outputs sensor data representing the distances and directions of measurement points on objects existing in the surrounding environment, or two-dimensional or three-dimensional coordinate values of such measurement points. The number of LiDAR sensors 140 is not limited to two, but may be one, or three or more.

The LiDAR sensors 140 may be configured to output two-dimensional or three-dimensional point cloud data as sensor data. In the present specification, “point cloud data” broadly means data indicating a distribution of multiple reflection points that are observed with the LiDAR sensors 140. The point cloud data may contain coordinate values of each reflection point in a two-dimensional space or a three-dimensional space or information indicating the distance and direction of each reflection point, for example. The point cloud data may include information of luminance of each reflection point. The LiDAR sensors 140 may be configured to repeatedly output point cloud data with a pre-designated cycle, for example. Thus, the external sensors may include one or more LiDAR sensors 140 that output point cloud data as sensor data.

The sensor data that is output from the LiDAR sensors 140 is processed by a controller configured or programmed to control self-traveling of the work vehicle 100. During travel of the work vehicle 100, based on the sensor data that is output from the LiDAR sensors 140, the controller can be configured or programmed to consecutively generate an obstacle map indicating a distribution of objects existing around the work vehicle 100. The controller may be configured or programmed to generate an environment map by joining together obstacle maps with the use of an algorithm such as SLAM, for example, during self-traveling. The controller can be configured or programmed to perform estimation of the position and orientation of the work vehicle 100 (i.e., localization) by matching the sensor data against the environment map.

The plurality of obstacle sensors 130 shown in FIG. 1 are provided at the front and the rear of the cabin 105. The obstacle sensors 130 may be provided at other positions. For example, one or more obstacle sensors 130 may be provided at any position at the sides, the front, or the rear of the vehicle body 101. The obstacle sensors 130 may include, for example, laser scanners or ultrasonic sonars. The obstacle sensors 130 may be used to detect obstacles in the surroundings during self-traveling to cause the work vehicle 100 to halt or detour around the obstacles.

The controller of the work vehicle 100 may be configured or programmed to utilize, to position, the sensor data acquired with the sensing devices such as the cameras 120 or the LIDAR sensors 140, in addition to the results of positioning provided by the positioning device 110. In the case where geographic features serving as characteristic points exist in the environment that is traveled by the work vehicle 100, as in the case of an agricultural road, a forest road, a general road, or an orchard, the position and the orientation of the work vehicle 100 can be estimated with a high accuracy based on data that is acquired with the cameras 120 or the LiDAR sensors 140 and on an environment map that is previously stored in the storage device. By correcting or complementing position data based on the satellite signals using the data acquired with the cameras 120 or the LiDAR sensors 140, it becomes possible to identify the position of the work vehicle 100 with a higher accuracy.

The work vehicle 100 and the implement 300 can communicate with each other via a communication cable that is included in the linkage device 108. The work vehicle 100 is able to communicate with a terminal device 400 for remote monitoring via a network 80. The terminal device 400 may be any arbitrary computer, e.g., a personal computer (PC), a laptop computer, a tablet computer, or a smartphone, for example.

The implement 300 includes a driver 340 (which may be referred to as the “second driver”), a driver 340, a controller 380, and a communicator 390. Note that FIG. 20 shows component elements which are relatively closely related to the operations of self-driving by the work vehicle 100, while other components are omitted from illustration.

The cameras 120 are imagers that image the surrounding environment of the work vehicle 100. Each camera 120 includes an image sensor such as a CCD (Charge Coupled Device) or a CMOS (Complementary Metal Oxide Semiconductor), for example. In addition, each camera 120 may include an optical system including one or more lenses and a signal processing circuit. During travel of the work vehicle 100, the cameras 120 image the surrounding environment of the work vehicle 100, and generate image (e.g., motion picture) data. The cameras 120 are able to capture motion pictures at a frame rate of 3 frames/second (fps: frames per second) or greater, for example. The images generated by the cameras 120 may be used by a remote supervisor to check the surrounding environment of the work vehicle 100 with the terminal device 400, for example. The images generated by the cameras 120 may also be used for the purpose of positioning or detection of obstacles. As shown in FIG. 1, the plurality of cameras 120 may be provided at different positions on the work vehicle 100, or a single camera 120 may be provided. A visible camera(s) to generate visible images and an infrared camera(s) to generate infrared images may be separately provided. Both of a visible camera(s) and an infrared camera(s) may be provided as a camera(s) for generating images for monitoring purposes. The infrared camera(s) may also be used for detection of obstacles at nighttime.

An obstacle sensor 130 detects objects around the work vehicle 100. The obstacle sensor 130 may include a laser scanner or an ultrasonic sonar, for example. When an object exists at a position closer to the obstacle sensor 130 than a predetermined distance, the obstacle sensor 130 outputs a signal indicating the presence of an obstacle. A plurality of obstacle sensors 130 may be provided at different positions of the work vehicle 100. For example, a plurality of laser scanners and a plurality of ultrasonic sonars may be located at different positions of the work vehicle 100. Providing a multitude of obstacle sensors 130 can reduce blind spots in monitoring obstacles around the work vehicle 100.

The driver 240 includes various types of devices required to cause the work vehicle 100 to travel and to drive the implement 300, for example, the prime mover 102, the transmission 103, the steering device 106, the linkage device 108 and the like described above. The prime mover 102 may include an internal combustion engine such as, for example, a diesel engine. The driver 240 may include an electric motor for traction instead of, or in addition to, the internal combustion engine.

The communicator 190 is a device including a circuit to communicate with the implement 300 and the terminal device 400. The communicator 190 includes circuitry to perform exchanges of signals complying with an ISOBUS standard such as ISOBUS-TIM, for example, between itself and the communicator 390 of the implement 300. This allows the implement 300 to perform a desired operation, or allows information to be acquired from the implement 300. The communicator 190 may further include an antenna and a communication circuit to exchange signals via the network 80 with the terminal device 400. The network 80 may include a 3G, 4G, 5G, or any other cellular mobile communications network and the Internet, for example. The communicator 190 may be configured or programmed to communicate with a mobile terminal that is used by a supervisor who is situated in a vicinity of work vehicle 100. With such a mobile terminal, communication may be performed based on any arbitrary wireless communication standard, e.g., Wi-Fi (registered trademark), 3G, 4G, 5G or any other cellular mobile communication standard, or Bluetooth (registered trademark).

The operation terminal 200 is a terminal for the user to perform a manipulation related to the travel of the work vehicle 100 and the operation of the implement 300, and is also referred to as a virtual terminal (VT). The operation terminal 200 may include a display device such as a touch screen panel, and/or one or more buttons. The display device may be a display such as a liquid crystal display or an organic light-emitting diode (OLED) display, for example. By manipulating the operation terminal 200, the user can perform various manipulations, such as, for example, switching ON/OFF the self-driving mode, switching ON/OFF a recording (teaching) mode and a reproducing (playback) mode, and switching ON/OFF the implement 300. At least some of these manipulations may also be realized by manipulating the operation switches 210. The operation terminal 200 may be configured so as to be detachable from the work vehicle 100. A user who is at a remote place from the work vehicle 100 may manipulate the detached operation terminal 200 to control the operation of the work vehicle 100. The operation terminal 200 may include a storage device. In place of the storage device 170, the storage device in the operation terminal 200 may store various data that is necessary for the operation of the work vehicle 100. The driver 340 in the implement 300 shown in FIG. 20 performs necessary operations for the implement 300 to perform predetermined tasks. The driver 340 includes a device that is adapted to the use of the implement 300, e.g., a hydraulic device, an electric motor, or a pump. The controller 380 is configured or programmed to control the operation of the driver 340. In response to signals that are transmitted from the work vehicle 100 via the communicator 390, the controller 380 is configured or programmed to cause the driver 340 to perform various operations. Moreover, a signal that is in accordance with the state of the implement 300 may be transmitted from the communicator 390 to the work vehicle 100.

Path generation methods according to example embodiments of the present invention is broadly applicable to various kinds of work vehicles for use in smart agriculture. With path generation methods and travel control systems according to example embodiments of the present invention, it is possible to achieve a more efficient travel of a work vehicle having an implement linked thereto within a field.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method, to be executed by one or more computers, to generate a path for a work vehicle having an implement linked thereto to travel within a field, the path including a temporary stop position in a peripheral region which is not a work area within the field but is an area provided along at least a portion of an outer periphery of the field, the method comprising:
calculating a space that is defined by a trajectory of the work vehicle and the implement when the work vehicle has performed a predetermined turn, based on a size of the work vehicle, a size of the implement, and a position relationship between the work vehicle and the implement; and
determining the temporary stop position based on the space.

2. The method of claim 1, wherein the calculating the space comprises:
acquiring information of a turning direction and a turning angle of the predetermined turn; and
calculating the trajectory based on the turning direction and the turning angle.

3. The method of claim 1, wherein the calculating the space comprises:
acquiring information of an upper limit value of a steering angle of the work vehicle that is tolerable when the work vehicle performs the predetermined turn; and
calculating the trajectory based on the upper limit value of the steering angle.

4. The method of claim 1, wherein the calculating the space comprises:
during travel between the temporary stop position and a travel restart position in the work area after stopping at the temporary stop position, acquiring information of one or more tolerable motions selected from among forward travel, backward travel, right turn, and left turn motions; and
calculating the trajectory based on the one or more tolerable motions.

5. The method of claim 1, wherein the path includes a turning section between the temporary stop position and a travel restart position within the work area after stopping at the temporary stop position.

6. The method of claim 1, wherein
the calculating the space comprises:
acquiring information of a method of linkage of the implement with the work vehicle;
calculating the trajectory based on a position relationship between the work vehicle and the implement that depends on the method of linkage; and
the information of the method of linkage includes information as to whether the implement is linked to the work vehicle such that an orientation of the implement is fixed relative to an orientation of the work vehicle.

7. The method of claim 6, wherein the calculating the space comprises:
acquiring information of an upper limit value of an angular difference between the orientation of the work vehicle and the orientation of the implement that is tolerable when the work vehicle performs the predetermined turn in a case where the orientation of the implement is not fixed relative to the orientation of the work vehicle; and
calculating the trajectory based on the upper limit value of the angular difference.

8. The method of claim 1, wherein the calculating the space comprises:
calculating a first length of the trajectory along a first direction that is parallel or substantially parallel to an orientation of the work vehicle before the predetermined turn; and
within a length of the trajectory along a second direction intersecting the first direction, calculating a second length of a portion of the trajectory that increases in a direction opposite to a direction of the predetermined turn, relative to a length along the second direction of the work vehicle before the predetermined turn.

9. The method of claim 8, wherein the determining the temporary stop position comprises:
determining the temporary stop position so that a rectangle that is determined by the first length and the second length is included in a predetermined region within the peripheral region.

10. The method of claim 9, wherein the predetermined region is in contact with the outer periphery of the field.

11. The method of claim 1, wherein
the outer periphery of the field includes a plurality of sides; and
the determining the temporary stop position comprises:
determining the temporary stop position so that the temporary stop position is located within a vicinity of one of the plurality of sides and that an orientation of the work vehicle at the temporary stop position is in a direction that is parallel or substantially parallel to a direction in which the one of the plurality of sides extends.

12. The method of claim 1, wherein the determining the temporary stop position comprises:
acquiring information as to which factor is to be prioritized between a distance of a connection path that connects the temporary stop position and a travel end position in the work area before stopping at the temporary stop position being short, and a curvature of the connection path being small; and
determining the temporary stop position by generating the connection path based on the prioritized factor.

13. The method of claim 1, wherein
the work area includes a plurality of crop rows; and
a path by which the work vehicle travels in the work area includes a path by which the work vehicle travels among the plurality of crop rows.

14. The method of claim 13, wherein the path by which the work vehicle travels in the work area further includes a path by which the work vehicle turns in a headland before and after the travel among the plurality of crop rows.

15. A controller configured or programmed to cause a work vehicle to travel along a path that is generated by the method of claim 1.

16. A travel control system comprising:
a processor configured or programmed to generate a path by carrying out the method of claim 1; and
a controller configured or programmed to cause a work vehicle to travel along the path that is generated by the processor.

17. A work vehicle comprising:
the travel control system of claim 16;
a travel device including a wheel responsible for steering; and
a driver to drive the travel device.

18. A processor configured or programmed to generate a path for a work vehicle having an implement linked thereto to travel within a field, the processor comprising:
one or more processors; and
one or more memories storing a computer program to be executed by the one or more processors; wherein
the path includes a temporary stop position in a peripheral region which is not a work area within the field but is an area provided along at least a portion of an outer periphery of the field; and
by executing the computer program, the one or more processors perform:
calculating a space that is defined by a trajectory of the work vehicle and the implement when the work vehicle has performed a predetermined turn, based on a size of the work vehicle, a size of the implement, and a position relationship between the work vehicle and the implement; and
determining the temporary stop position based on the space.

19. A non-transitory computer-readable medium including a computer program to be executed by a processor to generate a path for a work vehicle having an implement linked thereto to travel within a field, the path including a temporary stop position in a peripheral region which is not a work area within the field but is an area provided along at least a portion of an outer periphery of the field, the computer program being executable to cause the processor to perform:
calculating a space that is defined by a trajectory of the work vehicle and the implement when the work vehicle has performed a predetermined turn, based on a size of the work vehicle, a size of the implement, and a position relationship between the work vehicle and the implement; and
determining the temporary stop position based on the space.
